(19) United States
(12) Patent Application Publication
(10) Pub. No.: US 2026/0089529 A1
(43) Pub. Date: Mar. 26, 2026

(54) CANDIDATE CELL CQI REPORT TRIGGERING

(71) Applicant: InterDigital Patent Holdings, Inc., Wilmington, DE (US)

(72) Inventors: Brian Martin, Farnham (GB); Paul Marinier, Brossard (CA); Oumer Teyeb, Montreal (CA); Martino Freda, Laval (CA); Jonghyun Park, Syosset, NY (US); Young Woo Kwak, Woodbury, NY (US); Moon IL Lee, Melville, NY (US); Faris Alfarhan, Montreal (CA); Erdem Bala, East Meadow, NY (US)

(73) Assignee: InterDigital Patent Holdings, Inc., Wilmington, DE (US)

(21) Appl. No.: 19/109,467

(22) PCT Filed: Sep. 22, 2023
(86) PCT No.: PCT/US2023/074905

§ 371 Date: Mar. 6, 2025

Related U.S. Application Data
(60) Provisional application No. 63/410,800, filed on Sep. 28, 2022.
(60) Provisional application No. 63/421,780, filed on Nov. 2, 2022.
(60) Provisional application No. 63/445,526, filed on Feb. 14, 2023.

(51) Int. Cl. H04W 24/10; H04L 5/00

(52) U.S. Cl. CPC H04W 24/10; H04L 5/0048

(57) ABSTRACT

A WTRU may receive configuration information associated with neighbor cells, including indications of a first type of measurement, a second type of measurement, and/or a reporting condition associated with the first type of measurement. The first and second types of measurement may be LI measurements. The WTRU may perform a measurement associated with the first type of measurement on a neighbor cell. The WTRU may determine that the reporting condition is satisfied for the neighbor cell based on the measurement. The WTRU may transmit a request to activate the second type of measurement for the neighbor cell. The WTRU may receive an activation command for reporting a measurement associated with the second type on the neighbor cell. The WTRU may perform the measurement associated with the second type on the neighbor cell, and may transmit a report indicating one or more measurement values associated with the second type of measurement.

### CROSS-REFERENCE TO RELATED APPLICATIONS

This application claims the benefit of U.S. Provisional Ser. No. 63/410,800, filed on Sep. 28, 2022, U.S. Provisional Ser. No. 63/421,780, filed on Nov. 2, 2022, and U.S. es Provisional Ser. No. 63/445,526, filed on Feb. 14, 2023, the entire contents of which are incorporated herein by reference.

### BACKGROUND

In order to perform fast switching between cells, and in particular SpCells (e.g., PCell and/or PSCell), there may need to be some pre-configuration of the candidate cells at RRC layer, so that the configuration of the target SpCell(s) can be applied upon receiving an indication from L1/2. Candidate cells may have at least one of a SpCell configuration and an SCell configuration, which may be dynamically applied based on an indication at lower layers, either MAC CE or DCI.

However, frequent CSI reporting, particularly for multiple beams on multiple neighbor cells, may result in significant uplink signaling overhead. In addition, the burden on wireless transmit/receive unit (WTRU) processing may be significant if it needs to measure and report frequently on many non-serving cells/beams.

### SUMMARY

A wireless transmit/receive unit (WTRU) may receive a configuration of one or more measurement and reporting configurations of a first type, and one or more measurements of a second type. The WTRU may associate the measurements of the first and second types based on a condition. For example, the second type of measurements may be started when the condition based on the first type of measurements is met. The WTRU may perform measurements of the first type. The WTRU may evaluate a condition associated with measurements of the first type. The WTRU may perform measurements of the second type (e.g., once a condition associated with measurements of the first type is met). Dynamic configuration of QCL sources for TCI states and/or SSB resources for a CSI SSB resource set may be performed, for example based on the WTRU autonomously detecting best SSB resources.

The WTRU may receive, from a serving cell (e.g., network), configuration information associated with one or more neighbor cells. The configuration information may include an indication of a first type of measurement, an indication of a second type of measurement, and/or an indication of a reporting condition associated with the first type of measurement. For example, the first type of measurement may be a synchronization signal block (SSB) measurement, and the reporting condition may be a layer 1 (L1) measurement event triggering condition. The configuration information may include configuration information for the first type of measurement and the second type of measurement for each of a plurality of neighbor cells.

The WTRU may perform a measurement associated with the first type of measurement on a neighbor cell of the one or more neighbor cells. The WTRU may determine that the reporting condition is satisfied for the neighbor cell based on the measurement associated with the first type of measurement.

The WTRU may transmit, to the serving cell, a request to activate the second type of measurement for the neighbor cell based on the determination that the reporting condition is satisfied for the neighbor cell. The request may be included in a MAC CE and/or a scheduling request.

The WTRU may receive, from the serving cell, an activation command for reporting a measurement associated with the second type of measurement on the neighbor cell. The activation command may be received in one or more of a DCI or a MAC CE. The WTRU may perform the measurement associated with the second type of measurement on the neighbor cell and transmit, to the serving cell, a report indicating one or more measurement values associated with the second type of measurement. The second type of measurement may include channel state information reference signal (CSI-RS)-based measurements of one or more beams associated with the neighbor cell. The first type of measurement and the second type of measurement may be L1 measurements.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example high-level measurement model.

FIG. 3 illustrates an example of a handover scenario.

FIG. 4 illustrates an example of a conditional handover configuration and execution.

FIG. 5 illustrates an example of L1/2 inter-cell mobility operation using carrier aggregation, whereby the candidate cell group may be configured by RRC and a dynamic switch of PCell and SCell may be achieved using L1/2 signaling.

FIG. 6 illustrates an example of CSI reporting.

FIG. 7 illustrates an example of WTRU-controlled CSI reporting activation.

FIG. 8 illustrates an example of network-controlled CSI reporting activation.

FIG. 9 illustrates an example of WTRU autonomous CSI reporting in L1.

FIG. 10 illustrates an example of network-controlled CSI reporting activation in L1.

### DETAILED DESCRIPTION

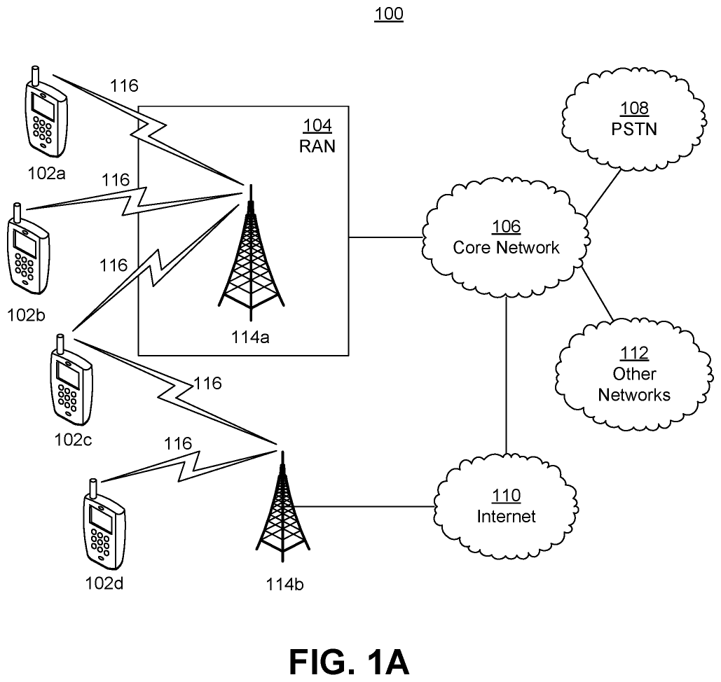

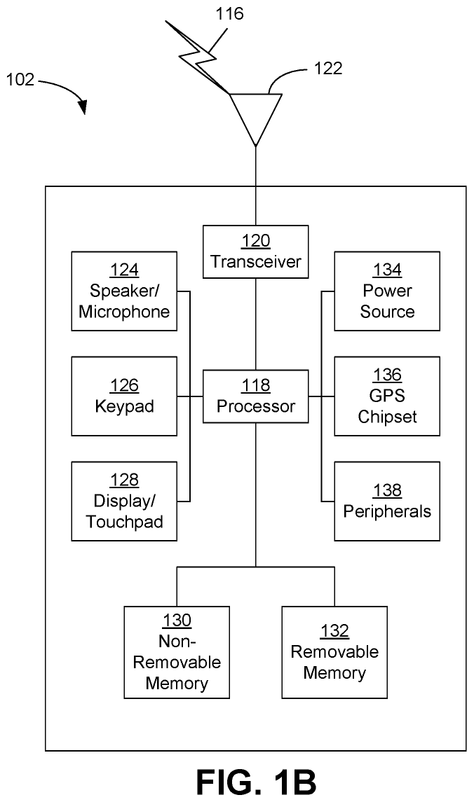

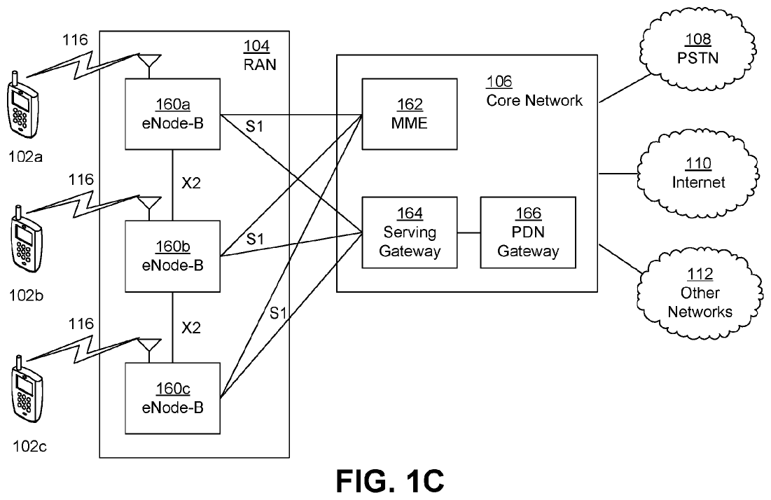

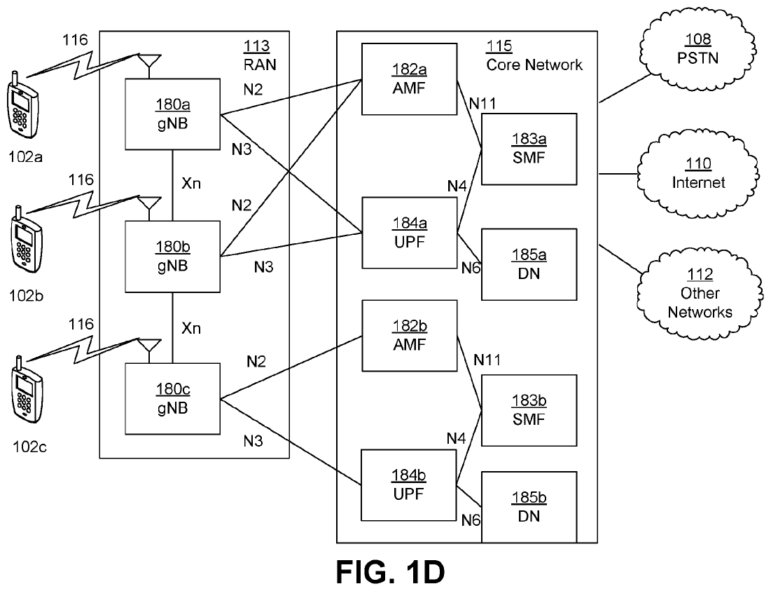

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless transmit/receive unit (WTRU) may perform one or more measurements. In an RRC_CONNECTED state, the WTRU may measure multiple (e.g., at least one) beams of a cell, and the measurement results (e.g., power values) may be averaged to derive the cell quality. In doing so, the WTRU may be configured to consider a subset of the detected beams. Filtering may take place at one or more (e.g., two) different levels: for example, at the physical layer to derive beam quality and at the RRC level to derive cell quality from multiple beams. Cell quality from beam measurements may be derived in the same way for the serving cell(s) and for the non-serving cell(s). Measurement reports may contain the measurement results of the X best beams (e.g., if the WTRU is configured to do so by the gNB).

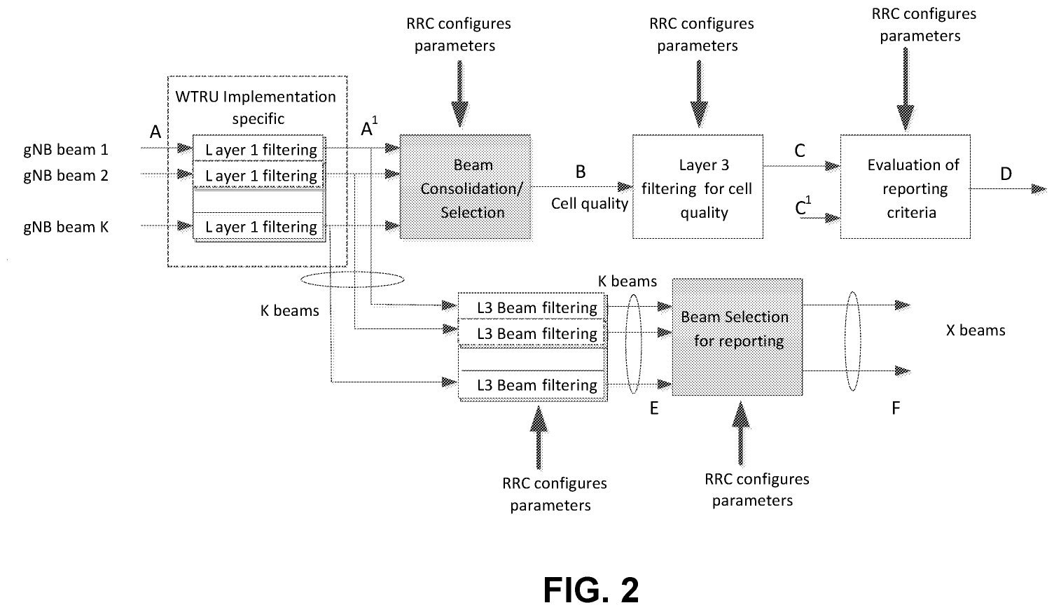

FIG. 2 illustrates an example high-level measurement model. As shown in FIG. 2, “K beams” may correspond to the measurements on SS block (SSB) or CSI-RS resources configured for L3 mobility by the gNB and detected by the WTRU at L1. “A” may refer to measurements (e.g., beam-specific samples) internal to the physical layer. “Layer 1 filtering” may refer to internal layer 1 filtering of the inputs measured at point A. Exact filtering may be implementation dependent. How the measurements are actually executed in the physical layer by an implementation (e.g., inputs A and Layer 1 filtering) may not be constrained. “A¹” may refer to measurements (e.g., beam-specific measurements) reported by layer 1 to layer 3 after layer 1 filtering. “Beam consolidation/selection” may refer to consolidating beam-specific measurements to derive cell quality. The behavior of the beam consolidation/selection may be standardized, and the configuration of this module may be provided by RRC signaling. A reporting period at B may equal a (e.g., one) measurement period at A¹.

As shown in FIG. 2, “B” may refer to a measurement (e.g., cell quality) derived from beam-specific measurements reported to layer 3 after beam consolidation/selection. “Layer 3 filtering for cell quality” may refer to filtering performed on the measurements provided at point B. The behavior of the Layer 3 filters may be standardized and the configuration of the layer 3 filters may be provided by RRC signaling. A filtering reporting period at C may equal a (e.g., one) measurement period at B. “C” may refer to a measurement after processing in the layer 3 filter. The reporting rate may be similar (e.g., identical) to the reporting rate at point B. This measurement may be used as input for one or more evaluation of reporting criteria. “Evaluation of reporting criteria” may refer to checking whether actual measurement reporting is necessary at point D. The evaluation may be based on more than one flow of measurements at reference point C (e.g., to compare between different measurements), for example as illustrated by inputs C and C¹. The WTRU may evaluate the reporting criteria (e.g., at least) every time a new measurement result is reported at point C, C¹. The reporting criteria may be standardized, and the configuration may be provided by RRC signaling (e.g., WTRU measurements). “D” may refer to measurement report information (e.g., message) sent on the radio interface.

As shown in FIG. 2, “L3 Beam filtering” may refer to filtering performed on the measurements (e.g., beam-specific measurements) provided at point A¹. The behavior of the beam filters may be standardized, and the configuration of the beam filters may be provided by RRC signaling. A filtering reporting period at E may equal a (e.g., one) measurement period at A¹. “E” may refer to a measurement (e.g., beam-specific measurement) after processing in the beam filter. The reporting rate may be identical to the reporting rate at point A¹. This measurement may be used as input for selecting the X measurements to be reported. “Beam Selection for beam reporting” may refer to selecting the X measurements from the measurements provided at point E. The behavior of the beam selection may be standardized, and the configuration of this module may be provided by RRC signaling. “F” may refer to beam measurement information included in a measurement report (e.g., sent) on the radio interface.

Layer 1 filtering may introduce a certain level of measurement averaging. How and when the WTRU performs the required measurements may be implementation-specific to the point that the output at B fulfils one or more performance requirements. Layer 3 filtering for cell quality and related parameters used may be specified, and may not introduce any delay in the sample availability between B and C. C¹ may be the input used in the event evaluation. L3 Beam filtering and related parameters used may be specified, and may not introduce any delay in the sample availability between E and F.

Measurement reports may be characterized by one or more of the following. Measurement reports may include the measurement identity of the associated measurement configuration that triggered the reporting. Cell and beam measurement quantities to be included in measurement reports may be configured by the network. The number of non-serving cells to be reported may be limited through configuration by the network. Cells belonging to an exclude-list configured by the network may not be used in event evaluation and/or reporting. Conversely, when an allow-list is configured by the network, (e.g., only) the cells belonging to the allow-list may be used in event evaluation and/or reporting. Beam measurements to be included in measurement reports may be configured by the network (e.g., beam identifier only, measurement result and beam identifier, and/or no beam reporting).

Intra-frequency neighbor (e.g., cell) measurements and inter-frequency neighbor (e.g., cell) measurements may be defined according to the following. A measurement may be defined as an SSB-based intra-frequency measurement if the center frequency of the SSB of the serving cell and the center frequency of the SSB of the neighbor cell are the same, and the subcarrier spacing of the two SSBs is also the same. A measurement may be defined as an SSB-based inter-frequency measurement if the center frequency of the SSB of the serving cell and the center frequency of the SSB of the neighbor cell are different, or if the subcarrier spacing of the two SSBs is different.

For SSB-based measurements, a (e.g., one) measurement object may correspond to a (e.g., one) SSB, and the WTRU may consider different SSBs as different cells.

A measurement may be defined as a CSI-RS based intra-frequency measurement provided that: the subcarrier spacing of CSI-RS resources on the neighbor cell configured for measurement is the same as the SCS of CSI-RS resources on the serving cell indicated for measurement; 60 kHz subcarrier spacing, the cyclic prefix (CP) type of CSI-RS resources on the neighbor cell configured for measurement is the same as the CP type of CSI-RS resources on the serving cell indicated for measurement; and/or the center frequency of CSI-RS resources on the neighbor cell configured for measurement is the same as the center frequency of CSI-RS resource on the serving cell indicated for measurement. A measurement may be defined as a CSI-RS based inter-frequency measurement if it is a CSI-RS based measurement that is not a CSI-RS based intra-frequency measurement. For example, the CSI-RS based measurement may be defined as a CSI-RS based inter-frequency measurement if one or more conditions are not met even if it is the same carrier (e.g., if the subcarrier spacing is different). Extended CP for CSI-RS based measurement may be supported.

Whether a measurement is non-gap-assisted or gap-assisted may depend on the capability of the WTRU, the active BWP of the WTRU, and/or the current operating frequency. For SSB-based inter-frequency measurement, if the measurement gap requirement information is reported by the WTRU, a measurement gap configuration may be provided according to the reported information. Otherwise, a measurement gap configuration may be (e.g., always) provided in the following cases: if the WTRU (e.g., only) supports per-WTRU measurement gaps and/or if the WTRU supports per-frequency range (FR) measurement gaps and any of the serving cells are in the same frequency range of the measurement object. For SSB-based intra-frequency measurement, if the measurement gap requirement information is reported by the WTRU, a measurement gap configuration may be provided according to the reported information. Otherwise, a measurement gap configuration may be (e.g., always) provided if, other than the initial BWP, any of the WTRU-configured BWPs do not contain the frequency domain resources of the SSB associated with the initial DL BWP.

In non-gap-assisted scenarios, the WTRU may be able to carry out such measurements without measurement gaps. In gap-assisted scenarios, the WTRU may not be assumed to be able to carry out such measurements without measurement gaps.

CSI reporting may be performed. CSI (channel state information) may be used as an indicator from the WTRU to the network on how good (e.g., or bad) a channel is at any point in time, and may be used by the gNB to make scheduling decisions, such as selection of a Modulation and Coding Scheme (MCS) and to assist with beamforming.

The time and frequency resources used by the WTRU to report CSI may be controlled by the gNB. CSI may include a Channel Quality Indicator (CQI), a precoding matrix indicator (PMI), a CSI-RS resource indicator (CRI), an SS/PBCH Block Resource indicator (SSBRI), a layer indicator (LI), a rank indicator (RI), L1-RSRP, L1-SINR, and/or Capability[Set]Index.

For CQI, PMI, CRI, SSBRI, LI, RI, L1-RSRP, L1-SINR, Capability[Set]Index, etc., a WTRU may be configured by higher layers with N (e.g., ≥1) CSI-ReportConfig Reporting Settings, M (e.g., ≥1) CSI-ResourceConfig Resource Settings, and/or a number of (e.g., one or two) list(s) of trigger states (e.g., given by the higher layer parameters CSI-Aperiodic TriggerStateList and/or CSI-SemiPersistentOnPUSCH-TriggerStateList). A (e.g., each) trigger state in CSI-Aperiodic TriggerStateList may contain a list of associated CSI-ReportConfigs indicating the Resource Set IDs for channel and optionally for interference. A (e.g., each) trigger state in CSI-SemiPersistentOnPUSCH-TriggerStateList may contain a (e.g., one) associated CSI-ReportConfig.

A (e.g., each) Reporting Setting CSI-ReportConfig may be associated with a (e.g., single) downlink BWP (e.g., indicated by higher layer parameter BWP-Id) given in the associated CSI-ResourceConfig for channel measurement, and may contain the parameter(s) for a (e.g., one) CSI reporting band: codebook configuration including codebook subset restriction, time-domain behavior, frequency granularity for CQI and PMI, measurement restriction configurations, and/or the CSI-related quantities to be reported by the WTRU (e.g., the layer indicator (LI), L1-RSRP, L1-SINR, CRI, SSBRI (SSB Resource Indicator), and/or Capability[Set]Index, etc.).

The time domain behavior of the CSI-ReportConfig may be indicated by the higher layer parameter reportConfigType and may be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset may apply in the numerology of the UL BWP in which the CSI report is configured to be transmitted on. The higher layer parameter reportQuantity may indicate the CSI-related, L1-RSRP-related, L1-SINR-related and/or Capability[Set]Index-related quantities to report. The reportFreqConfiguration may indicate the reporting granularity in the frequency domain, including the CSI reporting band and if PMI/CQI reporting is wideband or sub-band. The timeRestrictionForChannelMeasurements parameter in CSI-ReportConfig may be configured to enable time domain restriction for channel measurements, and timeRestrictionForInterferenceMeasurements may be configured to enable time domain restriction for interference measurements. The CSI-ReportConfig may contain CodebookConfig, which may contain configuration parameters for Type-I, Type II, Enhanced Type II CSI, and/or Further Enhanced Type II Port Selection including codebook subset restriction when applicable, and/or configurations of group-based reporting.

A (e.g., each) CSI Resource Setting CSI-ResourceConfig may contain a configuration of a list of S (e.g., ≥1) CSI Resource Sets (e.g., given by higher layer parameter csi-RS-ResourceSetList), where the list may include references to either or both of NZP CSI-RS resource set(s) and/or SS/PBCH block set(s). Alternatively, the list may include references to CSI-IM resource set(s). A (e.g., each) CSI Resource Setting may be located in the DL BWP identified by the higher layer parameter BWP-id, and one or more (e.g., all) CSI Resource Settings linked to a CSI Report Setting may have the same DL BWP.

The time domain behavior of the CSI-RS resources within a CSI Resource Setting may be indicated by the higher layer parameter resource Type, and may be set to aperiodic, periodic, or semi-persistent. For periodic and/or semi-persistent CSI Resource Settings, when the WTRU is configured with groupBasedBeamReporting-r17, the number of CSI Resource Sets configured may be a first value (e.g., S=2), otherwise the number of CSI-RS Resource Sets configured may be a second value (e.g., limited to S=1). For periodic and/or semi-persistent CSI Resource Settings, the configured periodicity and slot offset may be given in the numerology of its associated DL BWP, as given by BWP-id. When a WTRU is configured with multiple CSI-ResourceConfigs consisting of the same NZP CSI-RS resource ID, the same time domain behavior may be configured for the CSI-ResourceConfigs. When a WTRU is configured with multiple CSI-ResourceConfigs consisting of the same CSI-IM resource ID, the same time-domain behavior may be configured for the CSI-ResourceConfigs. One or more (e.g., all) CSI Resource Settings linked to a CSI Report Setting may have the same time domain behavior.

One or more of the following may be configured via higher layer signaling for one or more CSI Resource Settings for channel and interference measurement: CSI-IM resource for interference measurement; NZP CSI-RS resource for interference measurement; and/or NZP CSI-RS resource for channel measurement.

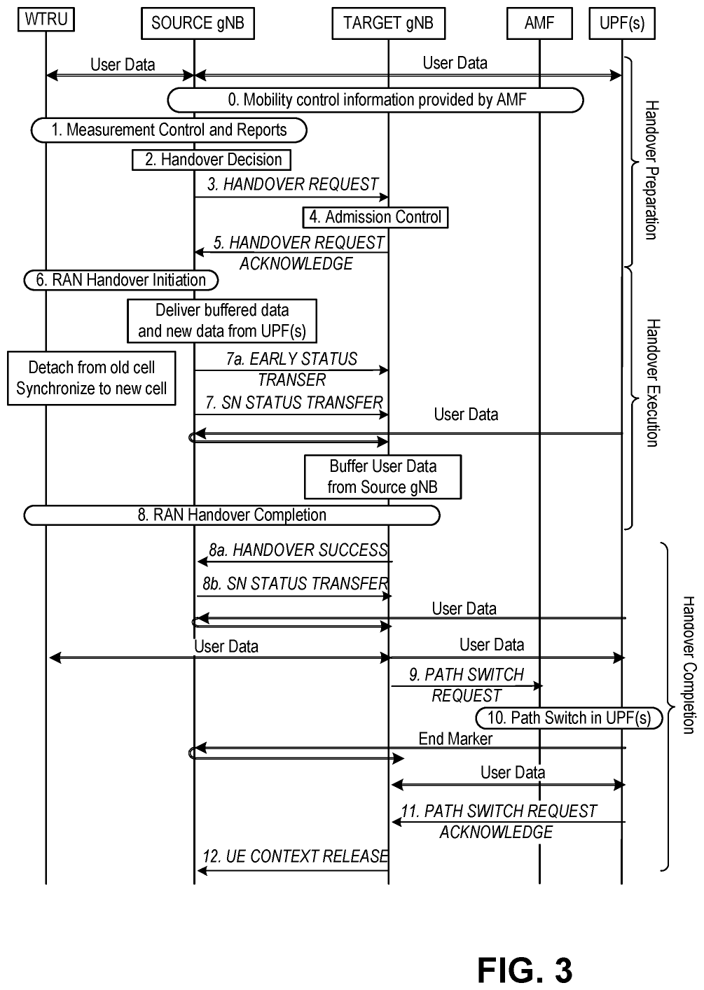

Handover may be performed. FIG. 3 illustrates an example of a handover scenario. As shown in FIG. 3, a WTRU context within a source gNB may contain information regarding roaming and access restrictions which were provided either at connection establishment or at the last TA (Timing Advance) update. The source gNB may configure the WTRU measurement procedures and the WTRU reports according to the measurement configuration. The source gNB may decide to handover the WTRU to a target gNB based on the received measurements. The source gNB may issue a Handover Request message to the target gNB passing a transparent RRC container with necessary information to prepare the handover at the target side. The information may include, for example, at least the target cell ID, a security key (e.g., KgNB*), the C-RNTI of the WTRU in the source gNB, RRM-configuration including WTRU inactive time, basic AS-configuration including antenna Info and DL Carrier Frequency, the current QoS flow to DRB mapping rules applied to the WTRU, the SIB1 from the source gNB, the WTRU capabilities for different RATs, PDU session related information, etc., and may include the WTRU reported measurement information including beam-related information (e.g., if available).

As shown in FIG. 3, admission control may be performed by the target gNB. If the WTRU can be admitted, the target gNB may prepare the handover with L1/L2 and may send the HANDOVER REQUEST ACKNOWLEDGE to the source gNB, which may include a transparent container to be sent to the WTRU as an RRC message to perform the handover. The source gNB may trigger the Uu handover by sending an RRCReconfiguration message to the WTRU, containing the information required to access the target cell: (e.g., at least) the target cell ID, the new C-RNTI, and/or the target gNB security algorithm identifiers for the selected security algorithms. It may include a set of dedicated RACH resources, the association between RACH resources and SSB(s), the association between RACH resources and WTRU-specific CSI-RS configuration(s), common RACH resources, and/or system information of the target cell, etc. The source gNB may send an SN STATUS TRANSFER message to the target gNB to convey the uplink PDCP SN receiver status and the downlink PDCP SN transmitter status of DRBs for which PDCP status preservation applies (e.g., for RLC AM).

As shown in FIG. 3, the WTRU may synchronize to the target cell and may complete the RRC handover procedure by sending an RRCReconfiguration Complete message to the target gNB. The target gNB may send a PATH SWITCH REQUEST message to the AMF to trigger 5GC to switch the DL data path towards the target gNB and to establish an NG-C interface instance towards the target gNB. 5GC may switch the DL data path towards the target gNB. The UPF may send one or more “end marker” packets on the old path to the source gNB per PDU session/tunnel, and then may release any U-plane/TNL resources towards the source gNB. The AMF may confirm the PATH SWITCH REQUEST message with a PATH SWITCH REQUEST ACKNOWLEDGE message. Upon reception of the PATH SWITCH REQUEST ACKNOWLEDGE message from the AMF, the target gNB may send a UE CONTEXT RELEASE message to inform the source gNB about the success of the handover. The source gNB may then release radio and C-plane related resources associated with the WTRU context. Any ongoing data forwarding may continue.

Conditional handover (CHO) and/or conditional PSCell Addition/Change (which may be referred to as “CPA,” “CPC,” and/or “CPAC”) may be performed in NR, with the main aim of reducing the likelihood of radio link failures (RLF) and handover failures (HOF).

Handover (e.g., legacy LTE/NR handover) may be triggered by measurement reports (e.g., even though there is nothing preventing the network from sending a HO command to the WTRU without receiving a measurement report). For example, the WTRU may be configured with an A3 event that triggers a measurement report to be sent when the radio signal level/quality (RSRP, RSRQ, etc) of a neighbor cell becomes better than the Primary serving cell (PCell) (e. g, or also the Primary Secondary serving Cell (PSCell), in the case of Dual Connectivity (DC)). The WTRU may monitor the serving and neighbor cells and may send a measurement report when the conditions get fulfilled. When such a report is received, the network (e.g., current serving node/cell) may prepare the HO command (e.g., an RRC Reconfiguration message, with a reconfigurationWithSync) and may send it to the WTRU, which the WTRU may execute immediately resulting in the WTRU connecting to the target cell.

CHO may differ from other types of handover (e.g., legacy handover) in one or more (e.g., two) main aspects. For example, in CHO, multiple handover targets may be prepared (e.g., as compared to only one target in legacy case). In CHO, the WTRU may not immediately execute the CHO (e.g., as in the case of the legacy handover). Instead, the WTRU may be configured with triggering conditions (e.g., a set of radio conditions), and the WTRU may execute the handover towards one of the targets (e.g., only) when/if the triggering conditions are fulfilled.

The CHO command may be sent when the radio conditions towards the current serving cells are still favorable, thereby reducing the two main points of failure in other types of handover (e.g., legacy handover). For example, the main points of failure may be that the WTRU risks failing to send the measurement report (e.g., if the link quality to the current serving cell falls below acceptable levels when the measurement reports are triggered in normal handover), and the failure to receive the handover command (e.g., if the link quality to the current serving cell falls below acceptable levels after the WTRU has sent the measurement report, but before it has received the HO command).

The triggering conditions for a CHO may be based on the radio quality of the serving cells and neighbor cells (e.g., like the conditions that are used in legacy NR/LTE to trigger measurement reports). For example, the WTRU may be configured with a CHO that has an A3-like triggering condition and associated HO command. The WTRU may monitor the current and serving cells, and when the A3 triggering condition is fulfilled, it may execute the associated HO command and switch its connection towards the target cell (e.g., instead of sending a measurement report).

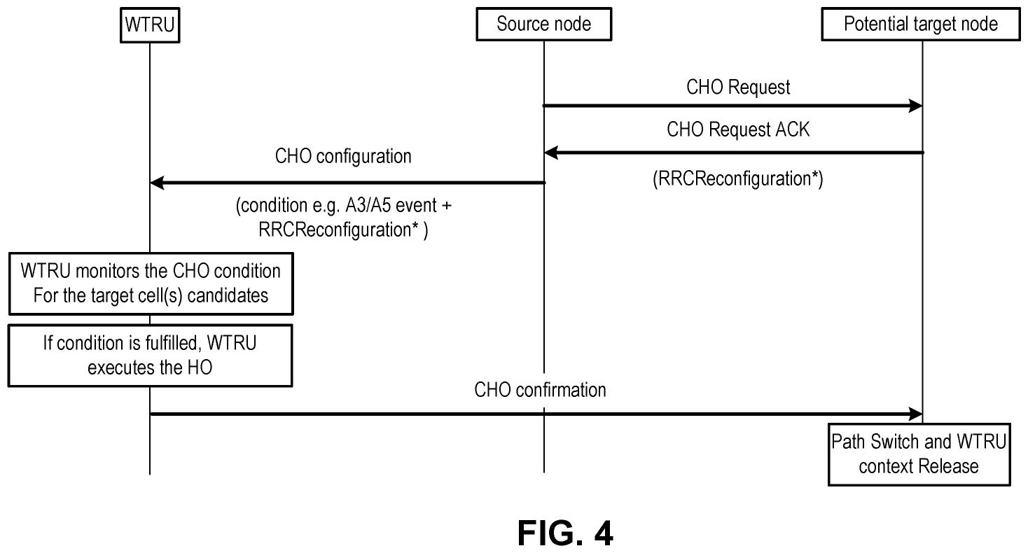

FIG. 4 illustrates an example of a conditional handover configuration and execution. CHO may help prevent unnecessary re-establishments in case of a radio link failure. For example, the WTRU may be configured with multiple CHO targets. The WTRU may experience an RLF before the triggering condition(s) with any of the targets is fulfilled. A type of operation (e.g., legacy operation) may have resulted in an RRC re-establishment procedure that would have incurred considerable interruption time for the bearers of the WTRU. However, in the case of CHO, if the WTRU, after detecting an RLF, ends up selecting a cell for which it has a CHO associated with (e.g., the target cell is already prepared for it), the WTRU may execute the HO command associated with this target cell directly (e.g., instead of continuing with the full re-establishment procedure).

CPC and CPA may be extensions of CHO (e.g., in DC scenarios). A WTRU may be configured with triggering conditions for PSCell change or addition, and when the triggering conditions are fulfilled, it may execute the associated PSCell change or PSCell add commands.

Inter-cell L1/2 mobility may be used. For example, inter-cell L1/2 mobility may be used to manage beams in a CA case. Cell change/add may be supported.

Mechanism(s) and/or procedure(s) of L1/L2 based inter-cell mobility for mobility latency reductions may be specified. Configuration and maintenance for multiple candidate cells may be performed to allow fast application of configurations for candidate cells (e.g., [RAN2, RAN3]). A dynamic switch mechanism may be used among candidate serving cells (e.g., including SpCell and SCell) for the potential applicable scenarios based on L1/L2 signaling (e.g., [RAN2, RAN1]). L1 enhancements for inter-cell beam management, including L1 measurement and reporting, and beam indication may be used (e.g., [RAN1, RAN2]). Early RAN2 involvement may be necessary, including the possibility of further clarifying the interaction between L1 enhancements for inter-cell beam management and dynamic switch mechanism among candidate serving cells. Timing Advance management may be used (e.g., [RAN1, RAN2]). CU-DU interface signaling to support L1/L2 mobility may be used (e.g., if needed) (e.g., [RAN3]).

FR2-specific enhancements (e.g., if any) may not be precluded. The procedure of L1/L2 based inter-cell mobility may be applicable to one or more of the following scenarios: Standalone, CA and NR-DC case with serving cell change within a (e.g., one) CG; Intra-DU case and intra-CU inter-DU case (e.g., applicable for Standalone and CA: no new RAN interfaces are expected); both intra-frequency and inter-frequency; both FR1 and FR2; source and target cells may be synchronized or non-synchronized; and an inter-CU case may not be included.

Inter-cell beam management may address intra-DU and/or intra-frequency scenarios. In this case the serving cell may remain unchanged (e.g., there is no possibility to change the serving cell using L1/2 based mobility). In FR2 deployments, CA may be used in order to exploit the available bandwidth (e.g., to aggregate multiple CCs in one band). These CCs may be transmitted with the same analog beam pair (e.g., gNB beam and WTRU beam). The WTRU may be configured with TCI states (can have fairly large number, e.g. 64) for reception of PDCCH and PDSCH. A (e.g., each) TCI state may include a RS or SSB that the WTRU may refer to for setting its beam. The SSB may be associated with a non-serving PCI. MAC signaling (e.g., “TCI state indication for UE-specific PDCCH MAC CE”) may activate the TCI state for a Coreset/PDCCH. Reception of PDCCH from a non-serving cell may be supported by MAC CE indicating a TCI state associated with a non-serving PCI. MAC signaling (e.g., “TCI States Activation/Deactivation for UE-specific PDSCH”) may activate a subset of (e.g., up to 8) TCI states for PDSCH reception. DCI may indicate which of the (e.g., 8) TCI states. A “unified TCI state” with a different updating mechanism (e.g., DCI-based), may be supported, with or without multi-TRP. A unified TCI state with multi-TRP may be supported.

L1/2 inter-cell mobility may be used to improve handover latency. With a conventional L3 handover or conditional, the WTRU may (e.g., first) send a measurement report using RRC signaling. In response to this, the network may provide a further measurement configuration and potentially a conditional handover configuration. With a conventional handover, the network may provide a configuration for a target cell after the WTRU reports using RRC signaling that the cell meets configured radio quality criteria. With conditional handover, in order to reduce the handover failure rate due to the delay in sending a measurement report and then receiving an RRC reconfiguration, the network may provide (e.g., in advance) a target cell configuration as well as measurement criteria which determines when the WTRU should trigger the CHO configuration. Both of these L3 methods, however, may suffer from some amount of delay due to the sending of measurement reports and receiving of target configurations, particularly in case of the conventional (e.g., non-conditional) handover.

L1/2 based inter-cell mobility may allow a fast application of configurations for candidate cells, including dynamically switching between SCells and switching of the PCell (e.g., switch the roles between SCell and PCell) without performing RRC signalling. The inter-CU case may not be included, as this may require relocation of the PDCP anchor. Therefore, an RRC based approach may be needed (e.g., at least) to support inter-CU handover.

With mechanisms (e.g., the legacy L3 handover mechanisms), a (e.g., any) currently active SCell(s) may be released before the WTRU completes the handover to a target cell in the coverage area of a new site, and may (e.g., only) be added back after successful handover, which may lead to throughput degradation during handover. One of the aims of L1/2 may therefore be to enable CA operation to be enabled instantaneously upon serving cell change.

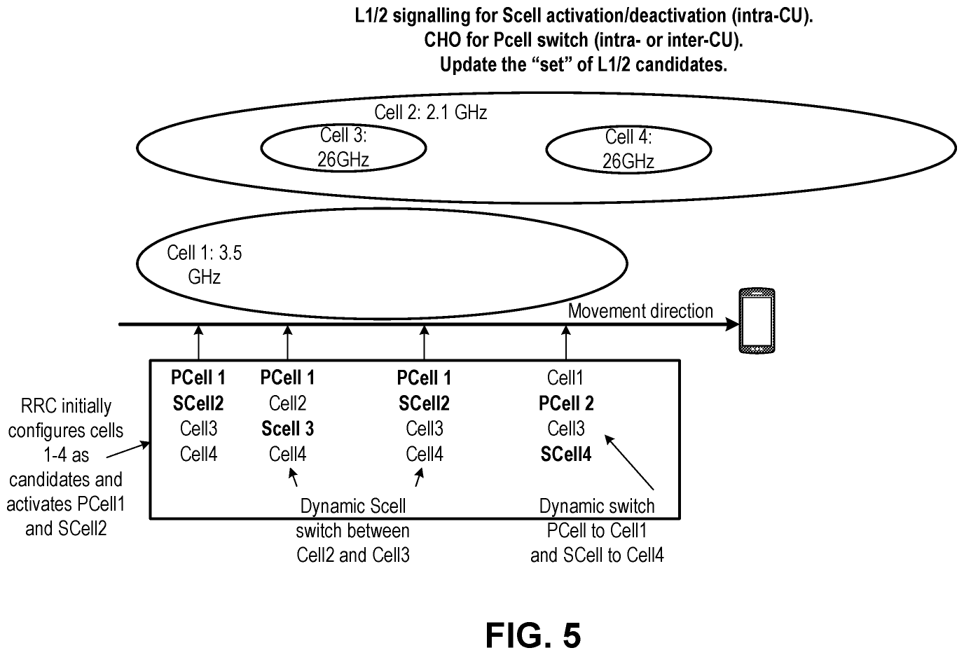

FIG. 5 illustrates an example of L1/2 inter-cell mobility operation using CA, whereby the candidate cell group may be configured by RRC, and a dynamic switch of PCell and SCell may be achieved using L1/2 signaling.

Mobility decisions (e.g., SCell addition/removal, SCell change, SpCell change, HO/CHO configuration, etc.) may be made based on measurement reporting (e.g., event) configurations, done at the RRC level. For example, the gNB may configure a CHO when a WTRU triggers a measurement report based on Event A2 (e.g., serving becomes worse than threshold). A SpCell change (e.g., HO) may be initiated based on the WTRU sending a measurement report that is triggered due to the fulfilment of event A3 (e.g., neighbor becomes offset better than SpCell) or event A5 (e.g., SpCell becomes worse than a first threshold (e.g., threshold1) and neighbor becomes better than a second threshold (e.g., threshold2). An SCell addition may be performed if the WTRU sends a measurement report that is triggered due to the fulfilment of event A4 (e.g., neighbor becomes better than threshold). An SCell change may be performed based on the fulfilment of event A6 (e.g., neighbor becomes offset better than Scell), etc.

In operations (e.g., legacy NR operations), if a CU-DU split architecture is employed, L1 measurements may be reported to the DU (e.g., CQI reports), which may be suitable for scheduling purposes. Since any cell changes or reconfigurations may require a significant amount of processing, these may not be performed too frequently based on the L1 signaling, and may be performed (e.g., only) when a stable measurement result for basing a reconfiguration decision can be determined. L3 measurements (e.g., measurements that are filtered at L3 to filter out short term fluctuations) may be used for making mobility decisions, and they may be sent to the CU, where the RRC may be terminated. Based on these L3 measurements, the CU's RRC may send reconfiguration messages that may instruct the WTRU to perform mobility (e.g., a HO command for immediate mobility, a CHO for mobility when certain conditions get fulfilled, etc.).

One way of implementing mobility based on L1/2 indications may be for the WTRU to send an RRC measurement report, and the CU may make the mobility decision and inform the DU to send the corresponding L1/2 indication. However, this may fail to result in latency reduction.

In addition, latency enhancements may be implemented, and L1 measurements may be used at least for triggering the cell change. While this may result in an increased ping-pong between cells (e.g., the L3 filtering over a longer time period minimizes this in legacy mobility), it may advantageously ensure the cell switch can be performed more quickly, reducing the possibility of RLF or handover failure. At least for the intra-DU case, the amount of reconfiguration may be minimized compared to legacy handover. For example, for cells belonging to the same DU, the L2 configuration may be shared, which may eliminate the need to perform a MAC reset and hence reduce the interruption time (e.g., and the reason for needing a long filtering and time to trigger).

However, frequent CSI reporting, particularly for multiple beams on multiple neighbor cells, may result in significant uplink signaling overhead. In addition, the burden on WTRU processing may be significant if it needs to measure and report frequently on many non-serving cells/beams.

CSI reporting may be used for fast evaluation of mobility decisions while minimizing overhead from frequent CSI reporting. CSI reporting may be enabled (e.g., only) when a candidate becomes likely for handover.

In an example, a WTRU may be configured with CSI Reporting configurations for beams on multiple candidate target cells (e.g., L1 per-beam measurements). The WTRU may be configured with one or more RRC measurement events (e.g., L3 per-cell measurements) and/or L1 measurement events, for example, Event A4 (e.g., neighbor becomes better than threshold), configured for candidate cells. The event may be associated with one or more of the CSI reporting configurations. When the cell meets event criteria based on cell level (L3) measurement or a second L1 measurement type, the beam (L1) measurements and CSI reporting associated with the candidate cell which triggered the RRC measurement event may be triggered. The WTRU may (e.g., autonomously) start reporting CSI when the event is triggered. Alternatively, the WTRU may first report to the NW (e.g., using MAC CE or SR) and wait for explicit CSI report activation/CSI request (e.g., via MAC CE or via DCI), which may be referred to as an activation command. The measurement type evaluated in order to trigger the CSI measurements may be an L1 measurement.

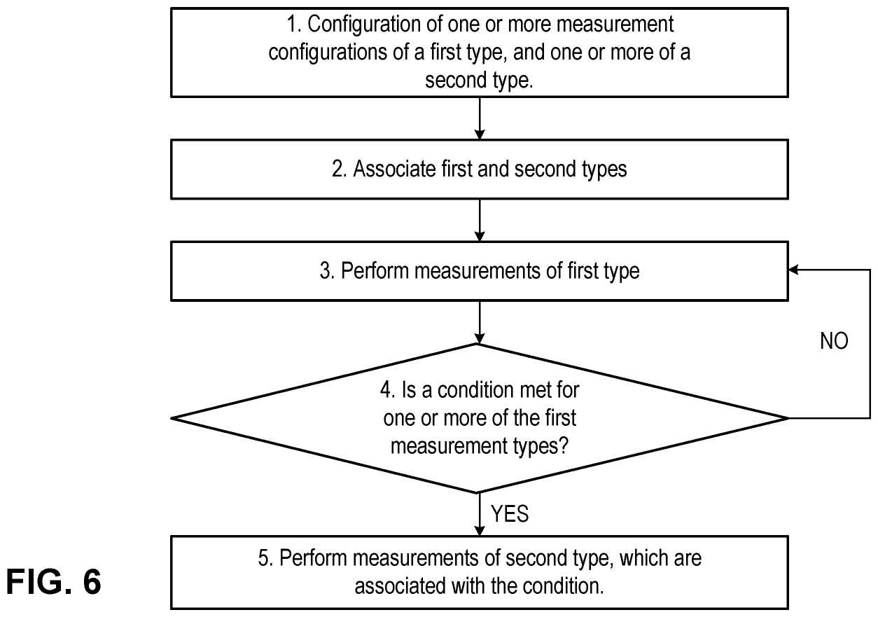

FIG. 6 illustrates an example of CSI reporting. As shown in FIG. 6, a WTRU may receive a configuration of one or more measurement and reporting configurations of a first type and one or more measurements of a second type for one or more neighbor cells. For example, the WTRU may receive (e.g., from a serving cell) configuration information associated with one or more neighbor cells. The configuration may include an indication of a first type of measurement, an indication of a second type of measurement, and/or an indication of a reporting condition associated with the first type of measurement. The first type of measurement configurations (e.g., the first type of measurement) may, for example, be L3/RRC measurement objects and reporting configurations (e.g., events) which are performed on a cell level. The second type of measurements may be L1/CSI measurements performed on a beam level. The first type of measurements may alternatively be L1/CSI measurements. The first type of measurements may use a longer filtering/average than the second type of measurements. The first type of measurement may be a synchronization signal block (SSB) measurement, and the reporting condition associated with the first type of measurement may be an L1 measurement event triggering condition. The configuration information may include configuration information for the first type of measurement and the second type of measurement for each of a plurality of neighbor cells.

The first type of measurements may be performed without any reporting to the network or with a reduced reporting to the network (e.g., a longer reporting period) compared to the second type of measurements (e.g., if the first type of measurement is L1/CSI measurements). The second type of measurements may be reported (e.g., periodically) to the network, or may be reported at a more frequent period than the first type of measurements.

The first type of measurements may be performed on a limited set of measurement resources compared to the second type of measurements. For example, the first type of measurements may measure SSB resources (e.g., wider beam), while the second type of measurements may measure CSI-RS resources (e.g., narrower beam). The first type of measurements may calculate an average (e.g., cell) measurement based on multiple beam measurements, while the second measurement type may consider individual beam measurements. The first type of measurements may be related to a first cell (e.g., an SpCell, an SCell, etc), while the second type of measurements may be related to a second cell (e.g., a candidate cell). Alternatively, the first and second type of measurements may be related to the same cell (e.g., a candidate and/or neighbor cell).

The WTRU may associate the measurements of the first and second types based on a condition (e.g., as part of a configuration). For example, the second type of measurements may be started when the condition (e.g., which was indicated in the configuration information received from the network) based on the first type of measurements is met. The WTRU may perform measurements of the first type. For example, the WTRU may perform a measurement associated with the first type of measurement on a neighbor cell of one or more neighbor cells. The WTRU may evaluate the condition associated with the measurements of the first type. For example, the WTRU may determine that the condition (e.g., reporting condition) is satisfied for the neighbor cell based on the measurement associated with the first type of measurement.

The condition may, for example, be a measurement event triggering condition (e.g., an L1 measurement event triggering condition). For example, if measurements performed using the first measurement type go below a threshold (e.g., associated with the PCell), then the associated measurement configuration of a second type (e.g., associated with a candidate cell) may be activated. The WTRU may automatically enable measurements of the second type based on meeting the condition associated with the first type. Alternatively, the WTRU may provide an indication to the network that the condition has been met (e.g., MAC CE), and the network may explicitly enable the measurements of the second type. For example, the WTRU may transmit a request to the network (e.g., serving cell) to activate the second type of measurement for the neighbor cell based on the determination that the reporting condition is satisfied for the neighbor cell, for example via a MAC CE and/or a scheduling request (SR). The WTRU may receive an activation command from the network (e.g., via MAC CE or DCI) for reporting a measurement associated with the second type of measurement on the neighbor cell.

The condition may, for example, be a measurement event triggering condition that is associated with associated with a serving cell and a candidate cell (e.g., a neighbor cell). For example, the condition may be related to an A3-like event, where the condition is fulfilled if the PCell falls a certain threshold below a candidate cell. For example, the condition may be related to an A5-like event, where the condition is fulfilled if the PCell falls a certain threshold, and the candidate cell becomes better than a certain threshold.

Once the condition associated with measurements of the first type is met, the WTRU may perform measurements of a second type. The measurements of the second type may be L1 measurements. The second measurement type may be, for example, a periodic CSI report of beam measurements. The beams measured (e.g., the CSI reporting configuration) may be associated with a cell measured using the first measurement type (e.g., the measurements of the second type may depend on which of the cells meet a condition, or which conditions are met). The WTRU may perform the measurements of the second type after receiving the activation command from the network.

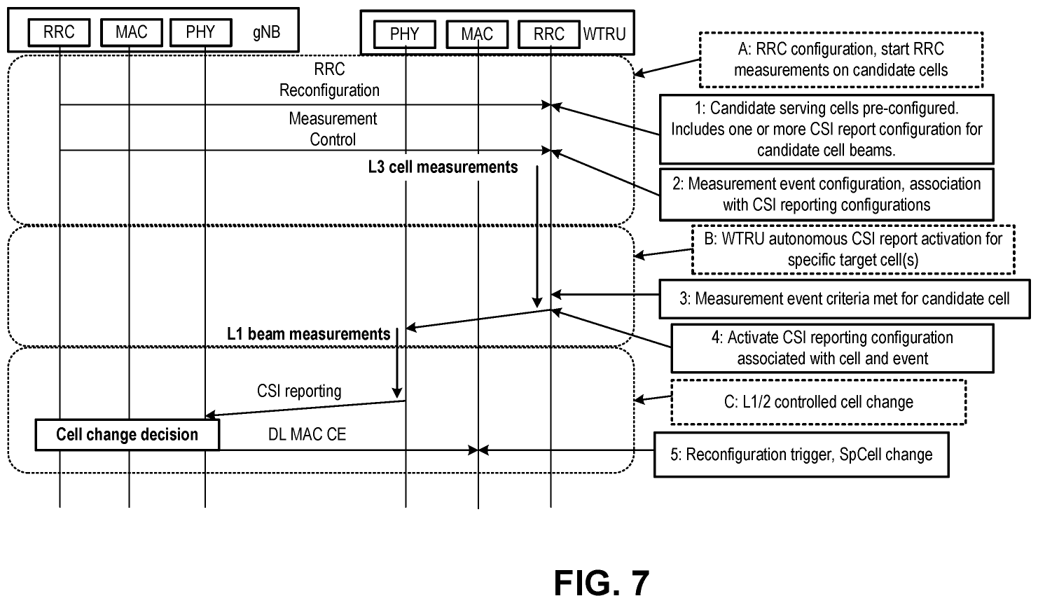

FIG. 7 illustrates an example of WTRU-controlled CSI reporting activation. For example, as shown in FIG. 7, the WTRU may control the activation of the second measurement type (e.g., CSI reporting). In the example shown in FIG. 7, there may be one or more (e.g., three) phases. These phases may be referred to as a first phase, a second phase, and a third phase; and/or as phase A, phase B, and phase C (e.g., as shown in FIGS. 7-10).

As shown in FIG. 7 (e.g., in a first phase), configuration of candidate cells and measurements and/or reporting configurations for serving and candidate cells may be provided, whereby RRC may configure the candidate serving cells. Candidate serving cells may be configured to be associated with particular CSI reporting configurations, corresponding to resources and reporting configurations for beams on that candidate cell. RRC measurements may be configured, and an association with the configured CSI report configurations may be made. The RRC measurement events configured for the L3 (e.g. cell) measurements may be associated with one or more CSI report configurations. For example, RRC measurement event(s) may be configured such that if a particular cell meets the event criteria, then a CSI reporting configuration corresponding to beams on that particular cell will become active. If the measurement event criteria is met for a different cell, then a different CSI reporting configuration may become active, for example one which corresponds to the beams on the different cell. The above may be performed in any order, together, or in multiple smaller steps.

As shown in FIG. 7 (e.g., in a second phase), the WTRU may perform the configured measurements, apply L3 filtering, and/or evaluate the measurement event criteria. The measurement event criteria may be met. Some specific examples of measurement event criteria may be, but are not limited to, one or more of the following: Event A3 (neighbor or candidate cell becomes offset better than SpCell); Event A4 (neighbor or candidate cell becomes better than threshold); and/or Event A5 (SpCell becomes worse than a first threshold (e.g., threshold1) and neighbor or candidate cell becomes better than a second threshold (e.g., threshold2)). When the conditions for a measurement event are met, the WTRU may activate the CSI reporting configuration associated with that event. This may consist of an indication to layer 1 that the WTRU should start performing CSI measurements on a particular resource or set of resources, and report using the configured reporting parameters. The WTRU may start performing and/or reporting the CSI measurements.

As shown in FIG. 7 (e.g., in a third phase), the network, utilizing the CSI, may report to decide on when to trigger the cell change to the preconfigured target SpCell using, for example, MAC CE or DCI. In an example, the WTRU may perform periodic CSI reporting. The WTRU or the NW may apply some filtering (e.g., averaging) of the CSI measurements. The network may decide, based on the periodically reported measurements, when the target cell is better than the current cell and hence when to issue the cell change command. In another example, the CSI report may (e.g., also) be event triggered. For example, the CSI report may be transmitted to the network (e.g., only) when one or more beams on the target cell become better than one or more beams on the current cell. Thus, there may be one or more (e.g., two) measurement events. A first measurement event may be based on RRC measurements and may be used to determine when to enable CSI measurements, and a second measurement event may be based on the CSI measurements and may determine when to send the CSI report to the network.

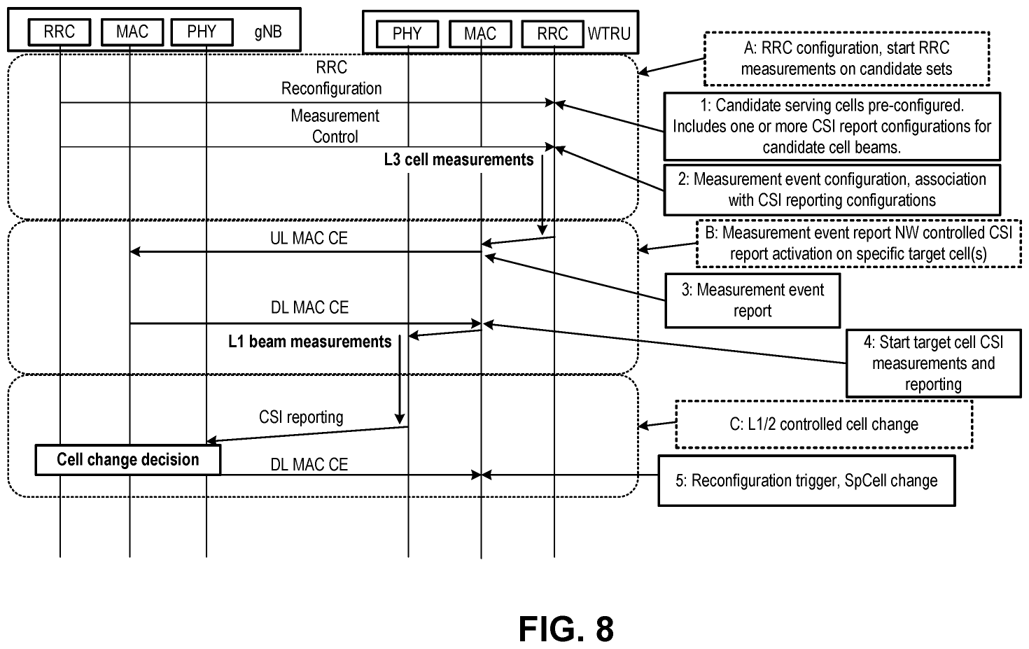

FIG. 8 illustrates an example of network-controlled CSI reporting activation. For example, as shown in FIG. 8, the network may control the activation of the second measurement type (e.g., CSI reporting). In the example shown in FIG. 8, there may be one or more (e.g., three) phases. A first phase in FIG. 8 may be similar to (e.g., the same as) the first phase of FIG. 7.

As shown in FIG. 8 (e.g., in a second phase), the WTRU may report an RRC measurement event to the network, for example using a MAC CE (e.g., rather than the WTRU enabling the CSI reporting configuration by itself when the RRC measurement event is met for a cell). The network may enable the CSI reporting (e.g., explicitly) using, for example, a DL MAC CE. The WTRU may decide on its own to activate a CSI reporting configuration, but also report this event to the network. This may, for example, change the way that the CSI report content is interpreted. For example, the CSI report may correspond to beams on cell 1 if the measurement event report reports that cell 1 meets the criteria, while the CSI report may correspond to beams on cell 2 if cell 2 is reported to have met the criteria. A third phase in FIG. 8 may be similar to (e.g., the same as) the third phase of FIG. 7.

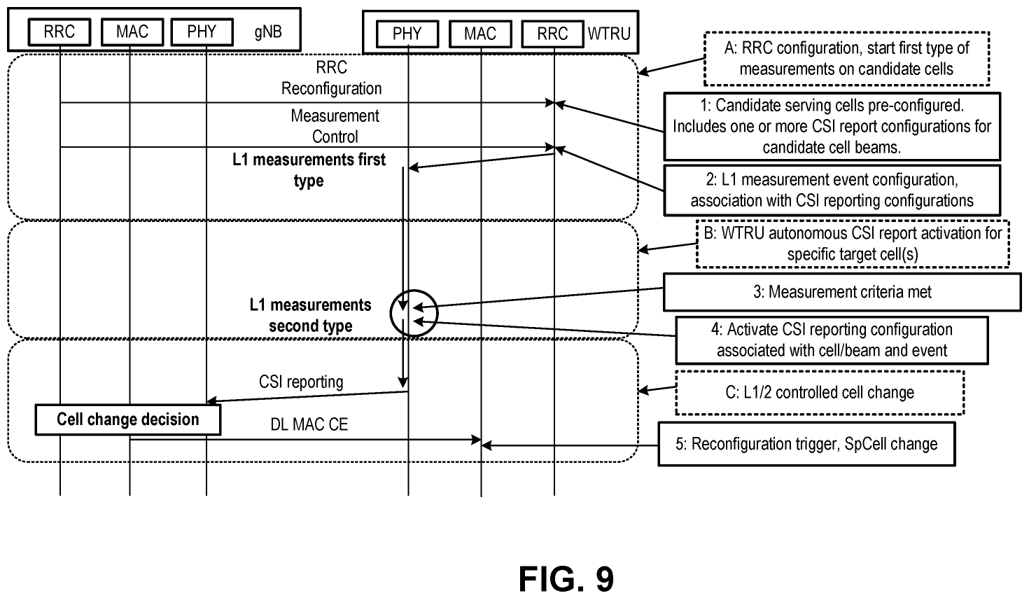

FIG. 9 illustrates an example of WTRU autonomous CSI reporting in L1. As shown in FIG. 9, both the first and second types of measurements may be based on L1 measurements. In the example shown in FIG. 9, there may be one or more (e.g., three) phases.

As shown in FIG. 9 (e.g., in a first phase), the WTRU may perform measurements of a first type in L1. These may, for example, be CSI measurements (e.g., without performing any report to the network). These measurements may be performed less frequently than the second measurement type, for example to monitor for beams on multiple cells. An event configuration may be provided to L1 such that the second type of measurements is activated when a condition associated with the first type of measurements is met. The WTRU may, for example, start performing more frequent CSI measurements and/or CSI reporting on one or more particular beams which are determined using the first measurement type. A second phase and a third phase in FIG. 9 may be similar to (e.g., the same as) the second phase and third phase, respectively, of FIG. 7.

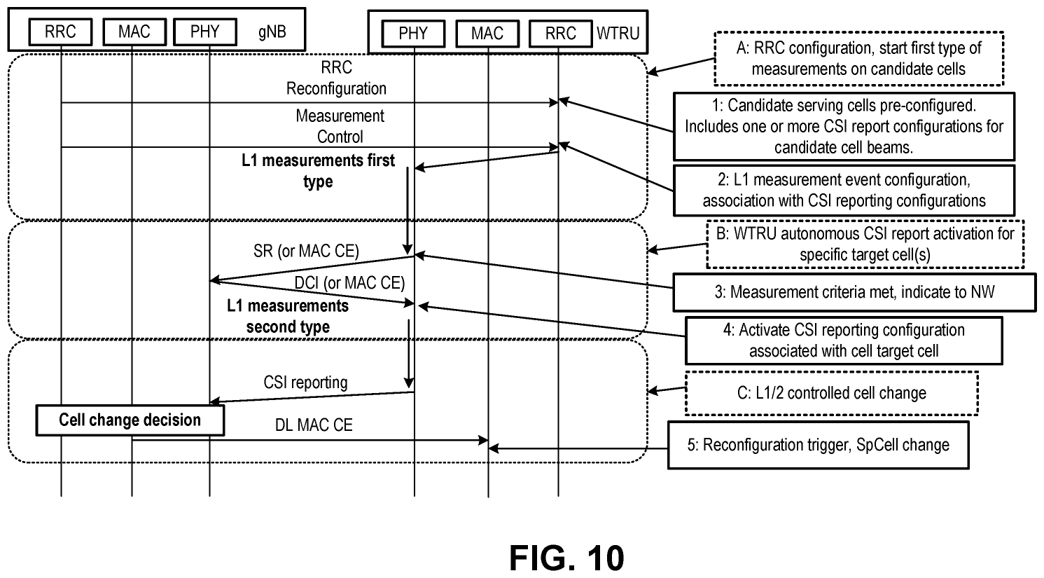

FIG. 10 illustrates an example of network-controlled CSI reporting activation in L1. In the example shown in FIG. 10, both the first type of measurements and the second type of measurements may be based on L1 measurements. The WTRU may indicate a condition is met using a request (e.g., a scheduling request or MAC CE), and the network may enable the CSI reporting configuration using DCI or MAC CE (e.g., via an activation command).

For example, as shown in FIG. 10, the WTRU may receive (e.g., from a serving cell), configuration information associated with one or more neighbor cells. The configuration information may include an indication of a first type of measurement, an indication of a second type of measurement, and/or an indication of a reporting condition associated with the first type of measurement. For example, the first type of measurement may be a SSB measurement, and the reporting condition may be an L1 measurement event triggering condition. The configuration information may include configuration information for the first type of measurement and the second type of measurement for one or more of the neighbor cells (e.g., each of a plurality of neighbor cells).

The WTRU may perform a measurement associated with the first type of measurement on a neighbor cell (e.g., of the one or more neighbor cells). The WTRU may determine that the reporting condition is satisfied for the neighbor cell based on the measurement associated with the first type of measurement. The WTRU may transmit (e.g., to the serving cell) a request to activate the second type of measurement for the neighbor cell based on the determination that the reporting condition is satisfied for the neighbor cell (e.g., in a MAC CE and/or a scheduling request).

The WTRU may receive (e.g., from the serving cell) an activation command for reporting a measurement associated with the second type of measurement on the neighbor cell (e.g., in a DCI and/or a MAC CE). The WTRU may perform the measurement associated with the second type of measurement on the neighbor cell and may transmit (e.g., to the serving cell) a report indicating one or more measurement values associated with the second type of measurement. The second type of measurement may include channel state information reference signal (CSI-RS)-based measurements of one or more beams associated with the neighbor cell. The first type of measurement and the second type of measurement may be L1 measurements.

Additionally, although one or more of the methods disclosed herein are described from the perspective of the WTRU, it is to be understood that the network (e.g., base station) may perform corresponding actions. For example, the network (e.g., base station) may transmit the configuration information and/or the activation command disclosed herein to the WTRU, and/or may receive the request and/or the measurement report disclosed herein from the WTRU.

In an example, the first type of measurement may be a L3 measurement. This measurement may be, for example, configured to use SSB resources (e.g., which are always transmitted as they are used for initial access). These resources may be provided over a wider beam, and no additional overhead may be associated with using these resources for mobility measurements. The L3 measurement may determine a cell quality based on averaging L1 measurements on one or more beams. The L3 measurement may use a longer filtering process and a longer time to trigger the measurement event. The L3 measurement may utilize measurement events, and for example may be configured with one or more of the following: Event A1 (e.g., serving cell becomes better than threshold); Event A2 (e.g., serving cell becomes worse than threshold); Event A3 (e.g., neighbor cell becomes offset better than SpCell); Event A4 (e.g., neighbor cell becomes better than a threshold); Event A5 (e.g., SpCell becomes worse than a first threshold (e.g., threshold1) and neighbor cell becomes better than a second threshold (e.g., threshold2)); Event A6 (e.g., neighbor cell becomes an offset better than SCell); Event B1 (e.g., inter-RAT neighbor cell becomes better than a threshold); Event B2 (e.g., PCell becomes worse than a first threshold (e.g., threshold1) and inter-RAT neighbor cell becomes better than a second threshold (e.g., threshold2)); Event I1 (e.g., interference becomes higher than a threshold); Event D1 (e.g., distance criteria between WTRU and reference location parameters); and/or CondEvent T1 (e.g., the time measured at WTRU is greater than a threshold and less than a threshold+duration).

Further measurement events may be introduced to support L1/2 mobility. For example any of the above events may be updated to compare serving, candidate, and/or neighbor cells, or a new event definition comparing serving cells may be defined. Any type of measurement event may be configured to evaluate the first type of measurements in order to trigger the second type of measurements. For example, a new measurement event which triggers, using the first type of measurements, when a candidate cell comes within X dB of serving may be used to enable the second type of measurements.

In an example, the second type of measurement may be a L1 measurement. This measurement may be configured to use CSI-RS resources (e.g., which may not necessarily be always transmitted). Usage of these resources may be associated with additional overhead; however, they may be transmitted over a narrower beam and therefore may provide a more accurate measurement of source and target beams.

In an example, both the first type and the second type of measurements may be L1 measurements. The first and second type of L1 measurements may be configured using different modes of operation. For example, the first type may measure SSB resources and the second type may measure CSI-RS resources. The first type of measurement may be configured such that the WTRU performs measurements of the first type at a lower rate than the second type. The second type of measurements may include reporting of measurement results to the networks. In order to minimize the amount of reporting, the first type of measurement may report more infrequently (e.g., or never).

In an example, a mapping may be provided between cells and/or measurement events and PUCCH resource configurations. When the event is triggered, the CSI reports corresponding to the triggered event may be sent using some specific resources, which may (e.g., implicitly) inform the network which event has been triggered and therefore which cells/beams/measurement resources the CSI reports correspond to. In an example, the resources may be (e.g., explicitly) enabled by the network, for example following a WTRU report (e.g. using MAC CE) that a measurement event has been triggered. The network (NW) may, for example, enable PUCCH resources (e.g., explicitly) using a downlink control signal (e.g. MAC CE or DCI).

One or more of the embodiments described herein may enable the WTRU to indicate with low latency at which point the network should configure appropriate L1 (e.g., CSI) measurements and reporting for the purpose of L1/2 mobility, scheduling and/or network energy savings.

One or more of the embodiments described herein may further enable the network to adjust configuration of L3 measurements for more (e.g., or less) responsiveness as a function of measurements performed at L1.

As used herein, the term “carrier information” may be used to refer to one or more of the following: an SSB frequency; an SSB subcarrier spacing; and/or any other information element provided as part of a NR measurement object (MeasObjectNR), such as a measurement timing configuration, a reference frequency for mapping CSI-RS, an SSB configuration for mobility, and/or the like.

The carrier information may be signaled and/or represented by one or more of: an explicit indication of carrier information (e.g., as defined herein); the identity of a measurement object containing the carrier information; and/or the identity of a serving cell operating on the carrier.

A WTRU may perform an action when a condition is met for CSI measurements (e.g., CSI prompting). For example, a WTRU may be configured to perform a set of channel state information (CSI) measurements for at least one type of CSI over at least one set of CSI resources, and to perform an action when (e.g., or whether) a condition is met for the at least one type of CSI. The WTRU may be configured to perform first and second sets of CSI measurements over first and second sets of CSI resources, and to perform an action when or whether a condition related to first and second sets is met. The action may be, for example, a transmission of an indication that a condition is met, such as a MAC CE or a CSI prompting request, or the activation/deactivation of an associated CSI report configuration. This type of operation may be referred to as “CSI prompting”. This may correspond to the “L1 measurement first type” described herein.

One or more types of CSI may be utilized. For example, the types of CSI that may be utilized for the condition may include one or more of the following: L1-RSRP; L1-SINR; channel quality indication (CQI); rank indication (RI); precoding matrix indication (PMI); CSI-RS resource indicator (CRI); and/or SS block resource indicator (SSBRI).

One or more resources may be used for measurements and/or filtering. The WTRU may perform measurements on at least one set of SSB blocks, at least one set of non-zero-power CSI-RS (NZP CSI-RS) for channel measurements or interference measurements, and/or at least one set of zero-power CSI-RS for interference measurements. A (e.g., each) measurement resource may be configured as periodic, semi-persistent or aperiodic. The resource configuration may include carrier information.

The WTRU may be configured to perform filtering or averaging over multiple occasions of a measurement resource. The filtering may consist, for example, of an average or moving average of N occasions, or of an infinite impulse response (IIR) filter with a forget factor F (e.g., or filter coefficient K). The averaging window may be specified in terms of a time duration, in which case the WTRU may perform averaging over the number of samples contained in the time window.

The WTRU may be configured to perform filtering or averaging over a set of up to M resources, such as a set of NZP CSI-RS or SSB, for which a measurement quantity is above a certain configured threshold (ATC). The set of up to M resources may be a subset of a NZP CSI-RS resource set.

The WTRU may be configured to measure on a subset of occasions for a measurement resource. Such subset of occasions may be determined by configuring a set of measurement time windows that recur periodically. The WTRU may perform measurements on a measurement resource (e.g., only) when it overlaps in time with measurement time window. The set of measurement time windows may be configured by (e.g., at least) a periodicity, an offset and a window duration, where units may be in terms of frames, slots and/or symbols.

One or more conditions (e.g., reporting conditions) may be disclosed herein. The WTRU may determine if a condition (e.g., at least one of the following conditions) is satisfied. A condition may be identified by a “type.”

A first type of condition may be that the value of a CSI type for a set of resources is, or becomes, higher than (e.g., or lower than) a threshold. For example, a condition may be that L1-RSRP, L1-SINR, CQI or RI is or becomes higher than or lower than a threshold. The threshold may be an absolute value.

A second type of condition may be that the value of a CSI type changes, or changes by more than a threshold (e.g., positive or negative), with respect to a reference value of the CSI type. For example, a condition may be that SSBRI and/or CRI changes (e.g., by any value), that RI increases (e.g., or decreases) by more than a value (e.g., one (1)), or that L1-RSRP increases (e.g., or decreases) by more than a threshold.

A third type of condition may be that the value of a CSI type for a first set of resources is, or becomes, higher than (e.g., or lower than) the value of a CSI type for a second set of resources plus (e.g., or minus) an offset.

A fourth type of condition may be that the value of a CSI type for a first set of resources is, or becomes, higher than (e.g., or lower than) a threshold, where the threshold may depend on the value of a CSI type for a second set of resources. The second set of resources may be referred to as a “reference set,” and the corresponding value may be referred to as a “reference value”. For example, the threshold may correspond to the reference value minus or plus an offset. The WTRU may determine the reference set and/or reference value based on one or more of the following.

In an example, the reference set may be (e.g., explicitly) configured or signaled by RRC or in MAC CE such as the MAC CE activating the CSI prompting measurements.

In an example, the WTRU may determine that the reference set as the resource(s) indicated as reference signal(s) within the quasi-colocation information configured for the transmission configuration indication (TCI) state that is configured or activated for a configured control resource set. If the WTRU is configured with more than one control resource set, the WTRU may determine the reference set as the one for which the reference value is maximized or minimized. Alternatively, the WTRU may receive a configuration indicating which control resource set is used for the reference set determination.

In an example, the WTRU may determine a reference CSI report configuration, and may use the latest measured value or latest reported value of the corresponding CQI type as the reference value. The reference CSI report configuration may be signaled using, for example, a CSI-ReportConfigId by RRC or in MAC CE such as the MAC CE activating the CSI prompting measurements.

A fifth type of condition may be that the ranking of the value of a CSI type for a set of resources, within the values of a CSI type across multiple sets of resources, changes. For example, the condition may be that the set of CSI resources that has highest value of a CSI type (e.g. L1-RSRP) has changed.

A sixth type of condition may be a change in the L sets of resources for which the values of a CSI type are maximized (e.g., or minimized). For example, a condition may be that a set of resources becomes one of the L sets of resources for which L1-RSRP or L1-SINR is the highest.

A hysteresis or additional offset may be applied to any of the conditions described herein to prevent the WTRU determining a condition repeatedly because of small fluctuations of the value of a CSI type. In addition, a time-to-trigger (TTT) may be applied, such that the WTRU determines that a condition is triggered (e.g., only) if it is satisfied for the duration of the TTT.

A CSI prompting configuration (e.g., L1 measurement first type) may be used.

The WTRU may receive a configuration for at least one resource and/or parameter described herein by RRC signaling. This may include CSI measurement resources, filtering parameters, thresholds, reference values, reference sets, CSI type, type of condition, offset, ranking, hysteresis, and/or set size L, etc. Such configuration may be referred to as a “CSI prompting configuration” herein. A CSI prompting configuration may include an identity parameter. A CSI prompting configuration may be configured as a CSI reporting configuration (CSI-ReportConfig) characterized by a (e.g., newly defined) type (reportConfigType) (e.g. “prompting”). The WTRU may receive configurations for one or more such CSI prompting configurations.

The configuration of at least one CSI measurement resource set may be indicated by at least one identity of a CSI resource configuration (e.g., csi-ResourceConfigId), and/or by at least one identity of a NZP CSI-RS resource set, CSI-SSB resource set, and/or CSI-IM resource set.

The WTRU may receive MAC or DCI signaling activating or deactivating a CSI prompting configuration and possibly providing the indication for at least one resource or parameter for the configuration. For example, the WTRU may receive a set of threshold values by RRC signaling and may then receive an indication in a MAC CE of an applicable threshold value within the set for an applicable CSI prompting configuration. For example, the WTRU may receive an indication of a reference value for RI, CRI or SSBRI by RRC or in the MAC CE. For example, the WTRU may receive MAC signaling to activate or deactivate a set of CSI resources in the CSI prompting configuration. For example, the WTRU may receive an activation command (e.g., by MAC CE or DCI) indicating an applicable CSI type and/or condition type and/or threshold for the CSI prompting configuration (e.g., L1-RSRP becomes lower than a threshold).

A linked CSI reporting configuration may be used. For example, a CSI reporting configuration may be linked (e.g., or combined with) a CSI prompting configuration. In an example, the WTRU may receive, as part of a CSI prompting configuration, the identity of at least one other CSI reporting configuration (e.g., by CSI-ReportConfigId) that may be activated, deactivated (e.g., released) and/or triggered when the condition is met. Such configuration may be referred to as a “linked CSI reporting configuration”. Whether the at least one linked CSI reporting configuration is to be activated, deactivated and/or triggered may be configured as part of the CSI prompting configuration, and/or signaled by MAC CE or DCI. Instead of or in addition to the at least one CSI reporting configuration, the linked CSI configuration may include at least one aperiodic or semi-persistent CSI trigger state.

If the WTRU does not receive a configuration for linked CSI reporting configuration or trigger state, the WTRU may determine that any (e.g., or all other) configured CSI report configuration or trigger state is linked.

Alternatively, configurations for CSI prompting and a linked CSI reporting may be included as part of the same CSI reporting configuration, where additional parameters and resources in support of CSI prompting may be provided.

A CSI reporting configuration may be linked to an L3 measurement. In an example, the WTRU may receive, as part of a configuration for an L3 measurement identity (measid), the identity of a (e.g., at least one) CSI reporting configuration (e.g., by CSI-ReportConfigId) that may be activated, deactivated (e.g., released) and/or triggered, according to the event configuration associated with the measurement identity. The WTRU may (e.g., only) transmit a L3 measurement report when such linked CSI reporting configuration is not configured, or when (e.g., explicitly) indicated in the configuration. The WTRU may receive additional parameters that override parameters configured as part of the linked measurement object for the L3 measurement. For example, the WTRU may receive an applicable filtering coefficient K and/or a threshold for averaging over M resources. the WTRU may receive alternate reporting configuration parameters, possibly by reportConfigId. Such parameters may be signaled by RRC (e.g., as part of the L3 measurement configuration) and/or by MAC CE. RRC may configure multiple sets of candidate values for the parameters and/or reporting configuration identities, and the MAC CE may indicate the set of possible values along with the identity of the applicable L3 measurement.

The WTRU may autonomously activate a linked CSI reporting configuration. For example, when a condition is met for a CSI prompting configuration and/or when triggering occurs for an L3 measurement (measId), the WTRU may autonomously activate or deactivate the at least one linked CSI reporting configuration.

In an example, the WTRU may transmit dummy bits in place of CSI information in the resource configured for the linked CSI reporting configuration when it is not activated. This may have the benefit of avoiding ambiguity for the multiplexing of PUCCH and PUSCH from the network perspective.

The WTRU may transmit an indication (e.g., via MAC CE) notifying that the condition is met. For example, the WTRU may initiate transmission of signaling such as a MAC CE when the condition is met for a CSI prompting configuration. The MAC CE may contain one or more of the following: an identity of the CSI prompting configuration for which condition is met; value(s) of the CSI type for which condition is met; an identity of the linked CSI configuration or trigger state; an identity of the set of CSI resources for which condition is satisfied; and/or an indication of whether the condition is met, or the condition is no longer met.

The WTRU may initiate transmission of signaling such as MAC CE when triggering occurs for an L3 measurement. The MAC CE may contain one or more of the following pieces of information: an identity of the L3 measurement (measId) for which the condition is met; a MAC-level identity of the L3 measurement for which the condition is met; and/or measurement results.

The MAC CE may contain a MAC-level identity of the L3 measurement for which the condition is met. Such MAC-level identity may be signaled by RRC, for example as part of the configuration of the L3 measurement. Alternatively, the WTRU may receive a MAC CE indicating mapping between the L3 measurement identity (measId) and the MAC-level identity, for at least one L3 measurement identity.

The WTRU may modify an L3 measurement parameter if/when a condition is met. In an example, the WTRU may receive a configuration for at least one set of L3 measurement parameters, such as a filtering coefficient K, a number of SS-blocks or CSI-RS resources to average, and/or an absolute threshold for consolidation of CSI-RS or SS-block. The WTRU may further receive reporting configuration parameters, such as offsets, thresholds, hysteresis, and/or at least one identity of a reporting configuration (reportConfigId). The WTRU may further receive the identity of at least one L3 measurement (measId). The WTRU may further receive a first (e.g., or second) indication of an applicable set of L3 measurement parameters and/or reporting configuration parameters when a condition configured as part of a CSI prompting configuration is met (e.g., not met), for the at least one L3 measurement. The WTRU may apply the first or second set of L3 measurement parameters and/or the first or second set of reporting configuration parameters to the at least one L3 measurement when the condition is met (e.g., not met).

The WTRU may transmit a CSI prompting request when the condition is met. In an example, the WTRU may trigger a request to activate, de-activate and/or trigger the at least one linked CSI reporting configuration or trigger state when the condition is met and/or when an L3 measurement identity is triggered. The request may be referred to as a “CSI prompting request” or “CSI triggering request” or “Scheduling request for CSI”. The WTRU may transmit one or more CSI prompting requests until it receives signaling for the activation/de-activation or triggering for (e.g., one or all of) the at least one linked CSI reporting configurations and/or trigger states. The signaling may be a “SP-CSI on PUCCH activation/deactivation MAC CE”, a DCI activating or releasing semi-persistent CSI on PUSCH (e.g., DCI scrambled with SP-CSI-RNTI), and/or a DCI triggering aperiodic CSI associated with the linked CSI reporting configuration and/or trigger state.

The WTRU may follow the same procedure as for a scheduling request for the “CSI prompting request.”One or more of the following exceptions/additions may apply.

A CSI prompting request may be cancelled by the reception of signaling (e.g., as described herein). In the case of multiple linked CSI reporting configurations and/or trigger states, the condition for cancelling may be that signaling has been received for at least one of the linked reporting configurations and/or trigger states. Alternatively, the condition for cancelling may be that signaling has been received for multiple (e.g., all) linked reporting configurations and/or trigger states.

A CSI prompting request may not be cancelled by the transmission of a MAC PDU including a buffer status report (BSR).

A CSI prompting request may be cancelled if the condition associated with the CSI prompting configuration is no longer satisfied.

A CSI prompting request may be cancelled upon reception of signaling (e.g., from MAC CE) indicating to cancel the CSI prompting request. the signaling may indicate the identity of the CSI prompting configuration and/or of a linked CSI reporting configuration.

Transmission of a maximum number of CSI prompting requests may not result in initiation of a RACH procedure.

The WTRU may receive a configuration for the transmission of the CSI prompting request as part of the CSI prompting configuration. Such configuration may include, for example, the identity of a scheduling request configured by SchedulingRequestConfig. The associated scheduling request resource may be configured by SchedulingRequestResourceConfig that includes the identity of this scheduling request.

If a CSI configuration is linked to a L3 measurement, one or more configurations described herein may be included as part of the configuration associating the L3 measurement and the linked CSI configuration(s).

The WTRU may take one or more subsequent actions. The WTRU may deactivate a CSI prompting configuration when an event occurs. The event may be one or more of the following: transmission of the MAC CE notifying that condition is met; initiation of a CSI prompting request procedure; transmission of a first CSI prompting request after the condition is met; reception of signaling activating/deactivating/triggering CSI for the linked CSI report or trigger state; and/or cancellation of a CSI prompting request.

Alternatively, when the event occurs, the WTRU may continue measurements according to the CSI prompting configuration but change the condition to the opposite of the condition previously activated. For example, if the WTRU has an active CSI prompting configuration with a condition that the L1-RSRP for a set of resources becomes higher than a threshold (e.g., plus a hysteresis), the WTRU may change the condition to L1-RSRP for the set of resources becoming lower than the threshold (e.g., minus a hysteresis). The thresholds may be the same threshold or different thresholds. Alternatively, the WTRU may continue measurements and perform actions as described herein when the condition is no longer met.

CSI reporting enhancements for inter-frequency may be performed.

A WTRU may be configured with a CSI measurement configuration that includes one or more resource set(s) for a channel (e.g., SSB, NZP CSI-RS) and/or interference measurements (e.g., NZP CSI-RS, CSI-IM), where the resource set(s) may include carrier information for the purpose of measuring in another carrier (e.g., or bandwidth part) than the serving cell (e.g., or active bandwidth part). Such resource set may be referred to as an “inter-frequency” resource set herein, while a resource set that includes resources from the serving cell (e.g., serving carrier) may be referred to as an “intra-frequency” resource set herein. Alternatively, the WTRU may be configured with a resource set, where one or more (e.g., each) element(s) of the set may be associated with a different carrier. Such resource set may be referred to as a “mixed-frequency” resource set herein. If more than one resource set is configured for channel measurement (e.g., or interference measurement), a (e.g., each) resource set may be associated with a resource set indicator (RSI). Such RSI may be a new CSI report type.

The WTRU may further be configured with a CSI reporting configuration, which may be a CSI aperiodic or semi-persistent trigger state that includes both intra-frequency and inter-frequency resource sets and/or inter-frequency resource sets of multiple carriers, or that includes a mixed-frequency resource set.

The WTRU may be configured to include CSI corresponding to resources from multiple carriers in a single CSI report. The WTRU may indicate a resource within multiple sets of resources using a combination of RSI and CRI or SSBRI. Alternatively, the WTRU may report a new CSI type that extends (e.g., prepends or appends) the CRI or SSBRI with an RSI. This may be referred to as an extended CRI or SSBRI herein. Alternatively, the resource set may be identified by the order of the CRI and L1-RSRP within the report (e.g., intra-frequency resource set first, inter-frequency resource set second, etc.). The WTRU may include at least one CRI or SSBRI (e.g., or extended CRI or SSBRI, or RSI) and/or the L1-RSRP of the corresponding resource in the report. A CRI corresponding to a mixed-frequency resource set may have a larger number of bits than another CRI (e.g., a legacy CRI).

The WTRU may report a full (e.g., 7-bit) L1-RSRP corresponding to a resource and a differential (e.g., 4-bit) L1-RSRP for the remaining resource(s). The resource for which full L1-RSRP is reported may be the resource that has the highest L1-RSRP across one or more (e.g., all) resource sets. Alternatively, the resource may be the resource that has the highest L1-RSRP within the intra-frequency resource set (e.g., only). An additional bit may be appended to a differential L1-RSRP to indicate whether the difference is positive or negative.

A combination of one or more of RSI, CRI, SSBRI (e.g., or extended CRI, SSBRI), and/or L1-RSRP for a resource may be referred to as an L1 result herein.

The WTRU may include an L1 result from one or more (e.g., all) intra-/inter-frequency resource sets ranked by decreasing L1-RSRP.

The WTRU may include an L1 result from the intra-frequency resource set and from one or more (e.g., each) inter-frequency resource set(s). The WTRU may include an L1 result from an inter-frequency resource set if the L1-RSRP is higher than a threshold. The threshold may be, for example, an absolute threshold; the highest reported L1-RSRP (e.g., minus an offset); the highest reported intra-frequency L1-RSRP (e.g., minus an offset); and/or the highest reported L1-RSRP of the same intra-/inter-frequency (e.g., minus an offset). The threshold may be configured separately for one or more (e.g., each) intra-/inter-frequencies.

The WTRU may include an L1 result from an inter-frequency resource set if the highest L1-RSRP from the intra-frequency resource set is less than a threshold. The threshold may be configured separately for one or more (e.g., each) inter-frequencies.

The WTRU may be configured with a maximum number of L1 results in total and/or for an (e.g., each) intra-/inter-frequency.

The WTRU may include one or more of the following pieces of information in the report (e.g., in CSI part 1) to help the network decode the report: whether the L1 result is included for an (e.g., each) inter-frequency in CSI part 1 (e.g., using a bitmap indication); the total number of L1 results reported; and/or the number of L1 results reported for an (e.g., each) intra-/inter-frequency.

As described herein, the WTRU may receive one or more threshold(s), offset(s), and/or maximum numbers by RRC configuration (e.g., as part of a CSI reporting configuration, aperiodic/semi-persistent CSI state trigger configuration or measurement configuration) and/or by MAC CE.

A (e.g., each) configuration of an aperiodic CSI state trigger, semi-persistent CSI state trigger, and/or CSI report configuration may include an indication of whether inter-frequency L1 reports (e.g., or intra-frequency L1 reports) are to be included in the CSI report or not. Such indication may be configured separately for one or more (e.g., each) inter-frequencies. Alternatively, the aperiodic CSI field may be extended to indicate this information.

The WTRU may transmit a binary indication of whether a condition is met. For example, the WTRU may be configured to transmit at least one CSI report containing a binary indication of whether the condition is met for the CSI report instance. The resource (e.g. PUCCH resource) for the transmission of the CSI report may be signaled as part of the CSI prompting configuration or in a MAC CE activating the CSI prompting configuration.

TCI state groups may be provided. In an example, the WTRU may receive signaling (e.g., by RRC) for at least one group of TCI state configurations. The WTRU may further receive signaling (e.g., by MAC CE or DCI) to indicate the identity of a (e.g., one) such group for at least beam indication purpose related to subsequent dynamic signaling and/or existing configuration. For example, the WTRU may receive a first MAC CE indicating a group of TCI states. The WTRU may then receive a second MAC CE indicating a subset of TCI state identity(ies) for PDSCH and/or a TCI state for PDCCH. The WTRU may receive a DCI indicating a TCI state identity for downlink reception or uplink transmission. The WTRU may determine the applicable TCI state from the group received in the first MAC CE and/or the TCI state identity(ies) received in the second MAC CE or DCI. Alternatively, the WTRU may receive a (e.g., single) MAC CE indicating both a group of TCI states and a subset of TCI state identy(ies) within the group.

The WTRU may receive signaling (e.g., by MAC CE and/or DCI) to indicate the identity of a group of TCI state configurations applicable to at least one CSI report configuration, CSI resource configuration, CSI associated report configuration, and/or NZP CSI-RS resource configuration. Such signaling may also indicate, for at least one TCI state, the identity of such TCI state.

A WTRU may perform detection and/or reporting of SSB resources. The WTRU may detect and report, for example, up to K resources of a certain type, such as SSB resources for at least one bandwidth part and serving cell or carrier information. Such report may be referred to as an SSB report herein. The WTRU may indicate at least one of an SSB index, PCI, serving cell index, carrier information, and/or bandwidth part index for a (e.g., each) detected SSB resource. Such information may be referred to as parameters of the SSB resource herein. The same carrier information may be provided for a set of SSB resources. The WTRU may send a corresponding measurement result, such as L1-RSRP or L1-SINR, for a (e.g., each) resource. The WTRU may send such report using MAC CE, and may report the up to K detected resources for whichever measurement (e.g., L1-RSRP or L1-SINR) is highest. The WTRU may trigger transmission of the report upon reception of signaling by the network requesting the report and/or based on measurement results meeting certain criteria. For example, the WTRU may trigger transmission if there is a change in the set of up to K detected resources. The WTRU may also trigger according to a certain reporting configuration including an event defined (e.g., in legacy), such as a A3 event. The value of K, the bandwidth part identity, carrier information, the serving cell identity and/or the PCI may be signaled by the network (e.g., using MAC CE and/or RRC). Alternatively, the WTRU may autonomously detect applicable PCI.

Flexible TCI state(s) may be provided. In an example, the WTRU may receive (e.g., first) signaling indicating, for at least one TCI state, a TCI state configuration that includes more than one candidate quasi-colocation (QCL) sources of a same type, such as type D (e.g., spatial). One or more (e.g., each) of the at least one candidate QCL source(s) may include a configuration of serving cell, bandwidth part identity, physical cell identity, CSI-RS identity, SSB index, QCL type, pathloss reference, carrier information, uplink power control parameters, and/or the like. Such configuration may be referred to as a flexible TCI state. A (e.g., each) candidate QCL source may include a configuration for a zone or group identity, and a (e.g., each) flexible TCI state may also include a group identity. The WTRU may further receive (e.g., second) signaling (e.g., by MAC CE and/or DCI) indicating which candidate QCL source(s) is applicable to a flexible TCI state, for at least one flexible TCI state. Such candidate QCL source may be referred to as the “active” QCL source. For example, the WTRU may receive a MAC CE indicating a zone identity and possibly a set or group of TCI flexible states. If no set or group of TCI states is indicated, the WTRU may determine that the signaling is applicable to one or more (e.g., all) TCI states or flexible TCI states that include a candidate QCL source with the indicated zone identity. The WTRU may use the flexible TCI state at least for the purpose of CSI measurement and reporting, beam indication and/or beam failure recovery. For example, the WTRU may receive a configuration for a flexible TCI state in a NZP CSI-RS resource configuration, a CSI-RS resource set configuration, and/or a CSI associated report configuration, and may apply QCL information accordingly. Signaling required to modify a CSI reporting configuration may be minimized when the set of resources to measure needs to change as a result of mobility. In an example, the WTRU may be indicated of a set of flexible TCI states for beam failure recovery, and may determine that the set of recovery resources includes the set of active QCL sources of the flexible TCI states.

The WTRU may receive, for one or more TCI states, signaling indicating that one or more parameters identifying a QCL source configured for the TCI state(s) are to be determined by a dynamic aspect.

The WTRU may receive signaling (e.g., by MAC CE and/or DCI) indicating the at least one parameter of the candidate QCL source for the TCI state. For example, the WTRU may receive a MAC CE containing the identity of a TCI state, a SSB index, a PCI, and/or a serving cell index or carrier information. The WTRU may then determine the QCL source for this TCI state and serving cell based on the received SSB index, PCI, serving cell index and/or carrier information.

In an example, the WTRU may receive a MAC CE containing the identity of a set of resources and the identity of a TCI state for at least one TCI state. The WTRU may then determine that the QCL source for the Nth TCI state corresponds to the Nth resource of the set.

In an example, the WTRU may (e.g., first) receive signaling, such as MAC CE, including the identity of a TCI state for K TCI states and requesting that the WTRU detects and reports resources, such as SSB resources, to be configured as QCL sources for respective TCI states. The WTRU may then transmit the SSB report, including parameters of SSB resources as described herein. The WTRU may determine that the QCL source of the Nth TCI state corresponds to the Nth SSB resource included in the MAC CE.

In an example, the WTRU may transmit signaling, such as MAC CE, including a resource that the WTRU detected and/or corresponding measurement result(s), where the resource may be defined as one or more of PCI, SSB index, serving cell index, and/or carrier information. A first resource of the MAC CE may identify the QCL source for a first TCI state, a second resource may identify QCL source for a second TCI state, and so on. The WTRU may apply the association upon transmission of the PUSCH containing MAC CE, or upon reception of a MAC CE from the network confirming reception of the MAC CE transmitted by the WTRU.

In an example, the WTRU may receive signaling, such as MAC CE including a resource, where the resource may be defined as one or more of PCI, SSB index, serving cell index, and/or carrier information. A first resource of the MAC CE may identify the QCL source for a first TCI state, a second resource may identify QCL source for a second TCI state, and so on. The WTRU may apply the association after a time period following successful reception of the MAC CE or transmission of HARQ-ACK for the PDSCH carrying the MAC CE.

Flexible CSI resource configuration(s) for L1 measurement of candidate cells may be provided. The WTRU may measure and/or report CSI information such as RI, CQI, SSBRI, and/or CRI based on one or more measurement resource sets, where one or more elements of the set may depend on a dynamic aspect. For example, the dynamic aspect may be reception/transmission of MAC CE signaling and/or reception DCI signaling (e.g., dynamic signaling may include a MAC and/or DCI). Such resource set may be referred to as a dynamic resource set herein. Dynamic resource sets may be used when the WTRU autonomously and dynamically reports strongest resources (e.g., or beams) that it detects autonomously, and needs to perform L1 and/or CSI measurements on such resources (e.g., without RRC reconfiguration). The resources of a dynamic resource set may share common carrier information. The carrier information may be semi-statically configured (e.g., by RRC) for the dynamic resource set, or may be signaled by MAC CE. Alternatively, carrier information may be independently indicated for a (e.g., each) resource of the dynamic resource set.

The WTRU may receive dynamic signaling indicating resources to be included in a dynamic resource set. For example, the WTRU may receive a MAC CE including one or more of the following pieces of information: the identity of an applicable CSI measurement configuration, CSI reporting configuration, and/or aperiodic CSI triggering state; a type of resource set, such as whether the resource is an SSB (CSI-SSB-ResourceSet) or an NZP CSI-RS (NZP-CSI-RS-ResourceSet); the identity of a resource set, such as a CSI-SSB-ResourceSetId; carrier information applicable to the resource set; and/or, for one or more resources, one or more parameters identifying the resource, such as a SSB index, a PCI, and/or carrier information for a SSB resource, or a NZP CSI-RS resource Id for a NZP CSI-RS resource, and/or the index or order of the resource in the set, indicated either explicitly or implicitly from the order of the resource within the MAC CE.

The WTRU may receive a request to detect and/or report resources to be included in a dynamic resource set. For example, the WTRU may (e.g., first) receive signaling, such as MAC CE, including the identity of a resource set such as a CSI SSB resource set, and requesting that the WTRU detects and reports up to K SSB resources to be included in the resource set. The WTRU may perform such detection for certain carrier information signaled in the MAC CE or configured for the indicated resource set. The WTRU may transmit the SSB report as described herein, and may determine that the Nth resource of the resource set corresponds to the Nth SSB resource included in the MAC CE.

Dynamically-associated CSI-RS may be provided. A set of CSI-RS resources may be dynamically associated to SSBs to enable CSI reporting of narrower beams within a wider beam. One or more of the following steps may apply.

Configuration may be performed. The WTRU may be configured with a pool of CSI-RS resource sets per L1/L2 triggered mobility (LTM) area. The WTRU may be indicated (e.g., by the serving cell) with an index to one or more CSI-RS resource sets (e.g., the resource set may contain a CSI-RS resource) in the configured pool, where the indicated resource set may be defined to be “activated.”

L1 measurement may be performed. The WTRU may measure the set of configured SSBs in the LTM area, where an SSB may be associated with a cell other than the serving cell. The measurement may be RSRP. The WTRU may determine a first set of RSRP/SSB/PCI combination to report to the serving cell (e.g., the WTRU may report the best-N RSRP values and/or the corresponding SSB/PCI indexes). The measurements reported may be L1 filtered measurements. The WTRU may determine a subset of the SSB/PCI pairs from the first set. For example, the subset may comprise the SSB/PCI pair with the largest RSRP. The subset of SSB/PCI pairs may be indicated by the gNB (e.g., in a MAC CE #1).

Association may be performed. An activated CSI-RS resource set and an SSB/PCI from the subset of SSB/PCI pairs may be determined (e.g., by the WTRU) or indicated (e.g., by the gNB in a MAC CE #1) to be “associated.” As used herein, the term “associated” may mean that the SSB and the CSI-RS resource set are assumed to have a QCL relationship, such as QCL-C and/or QCL-D. The QCL reference of the CSI-RS resource set may be set to the SSB/PCI. The association may be indicated by the gNB and/or achieved via an implicit method. For example, in the implicit method, SSB/PCI pairs in the subset may be associated with CSI-RS resource sets (e.g., if there is any CSI-RS resource set available). For example, an SSB/PCI pair may be associated with an available (e.g., currently not associated) CSI-RS resource set, where the resource set may be the one with the lowest index. Association may follow one or more of the following rules: the association may be established/released/changed by the gNB (e.g., with a MAC CE); the association may apply under certain conditions, for example, certain SSB/PCI pairs may not be allowed for association (e.g., based on a priority parameter); and/or a CSI-RS resource set may become available (e.g., association is released) if the associated SSB/PCI pair drops out of the subset.

Reporting of CSI-RS measurement(s) may be performed. The WTRU may measure the associated CSI-RS (e.g., RSRP measurement) and may report to the serving cell (e.g., possibly filtered measurements). Reporting of the CSI-RS may be conditioned on one or more of the following: an RSRP (e.g., an average/best RSRP) of the CSI-RS resource set (e.g., which may be L1-filtered) is greater a threshold (e.g., above the RSRP of the associated SSB +offset); a CSI-RS resource set may be released if it does not meet the RSRP condition (e.g., over a time duration); and/or release of the association may be indicated to the gNB or the gNB may implicitly determine it from the WTRU reports.

One or more of the embodiments described herein may be extended to TCI states. A pool of TCI states may be configured, and a subset of the TCI states may be assigned to a WTRU. The signals that serve as the QCL sources of a TCI state may be dynamically updated, and may be sent to the SSB/CSI-RS candidates.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1-20. (canceled)

21. A wireless transmit/receive unit (WTRU) comprising:
a processor configured to:
receive, from a serving cell, configuration information associated with one or more neighbor cells, the configuration information comprising an indication of a first type of measurement, an indication of a second type of measurement, and an indication of a reporting condition associated with the first type of measurement;
perform a measurement of the first type on a neighbor cell of the one or more neighbor cells;
determine that the reporting condition is satisfied for the neighbor cell based on the measurement of the first type;
transmit, to the serving cell, an indication that the reporting condition is satisfied for the neighbor cell; and
receive, from the serving cell, an activation command for reporting one or more measurement values associated with the second type of measurement on the neighbor cell.

22. The WTRU of claim 21, wherein the processor is further configured to:
perform the measurement of the second type on the neighbor cell; and
transmit, to the serving cell, a report indicating the one or more measurement values associated with the second type of measurement.

23. The WTRU of claim 21, wherein the first type of measurement comprises a synchronization signal block (SSB) measurement, and wherein the reporting condition comprises a layer 1 (L1) measurement event triggering condition.

24. The WTRU of claim 23, wherein the processor being configured to determine that the reporting condition is satisfied for the neighbor cell based on the measurement of the first type comprises the processor being configured to:
determine that the measurement of the first type is greater than a threshold value.

25. The WTRU of claim 23, wherein the processor being configured to determine that the reporting condition is satisfied for the neighbor cell based on the measurement of the first type comprises the processor being configured to:
perform a second measurement of the first type on the serving cell;
determine that the measurement of the first type on the neighboring cell is greater than a first threshold value; and
determine that the second measurement of the first type on the serving cell is less than a second threshold value.

26. The WTRU of claim 21, wherein the indication that the reporting condition is satisfied for the neighbor cell comprises one or more of a MAC CE or a scheduling request.

27. The WTRU of claim 21, wherein the second type of measurement comprises channel state information reference signal (CSI-RS)-based measurements of one or more beams associated with the neighbor cell.

28. The WTRU of claim 21, wherein the first type of measurement and the second type of measurement are L1 measurements.

29. A method implemented in a wireless transmit/receive unit (WTRU), the method comprising:
receiving, from a serving cell, configuration information associated with one or more neighbor cells, the configuration information comprising an indication of a first type of measurement, an indication of a second type of measurement, and an indication of a reporting condition associated with the first type of measurement;
performing a measurement of the first type on a neighbor cell of the one or more neighbor cells;
determining that the reporting condition is satisfied for the neighbor cell based on the measurement of the first type;
transmitting, to the serving cell, an indication that the reporting condition is satisfied for the neighbor cell; and
receiving, from the serving cell, an activation command for reporting one or more measurement values associated with the second type of measurement on the neighbor cell.

30. The method of claim 29, further comprising:
performing the measurement of the second type on the neighbor cell; and
transmitting, to the serving cell, a report indicating one or more measurement values associated with the second type of measurement.

31. The method of claim 29, wherein the first type of measurement comprises a synchronization signal block (SSB) measurement, and wherein the reporting condition comprises a layer 1 (L1) measurement event triggering condition.

32. The method of claim 31, wherein determining that the reporting condition is satisfied for the neighbor cell based on the measurement of the first type comprises determining that the measurement of the first type is greater than a threshold value.

33. The method of claim 31, wherein determining that the reporting condition is satisfied for the neighbor cell based on the measurement of the first type comprises:
performing a second measurement of the first type on the serving cell;
determining that the measurement of the first type on the neighboring cell is greater than a first threshold value; and
determining that the second measurement of the first type on the serving cell is less than a second threshold value.

34. The method of claim 29, wherein the indication that the reporting condition is satisfied for the neighbor cell comprises one or more of a MAC CE or a scheduling request.

35. The method of claim 29, wherein the second type of measurement comprises channel state information reference signal (CSI-RS)-based measurements of one or more beams associated with the neighbor cell.

36. The method of claim 29, wherein the first type of measurement and the second type of measurement are L1 measurements.

37. A base station (BS) comprising:
a processor configured to:
transmit, to a wireless transmit/receive unit (WTRU), configuration information associated with one or more neighbor cells, the configuration information comprising an indication of a first type of measurement, an indication of a second type of measurement, and an indication of a reporting condition associated with the first type of measurement;
receive, from the WTRU, an indication that the reporting condition is satisfied for the
neighbor cell; and transmit, to the WTRU, an activation command for reporting one or
more measurement values
associated with the second type of measurement on the neighbor cell.

38. The BS of claim 37, wherein the processor is further configured to receive, from the WTRU, a report indicating one or more measurement values associated with the second type of measurement.

39. The BS of claim 37, wherein the activation command is transmitted in one or more of a downlink control information (DCI) or a medium access control (MAC) control element (CE).

40. The BS of claim 37, wherein the indication that the reporting condition is satisfied for the neighbor cell is received in or more of a MAC CE or a scheduling request.
